(19) United States
(12) Patent Application Publication
(10) Pub. No.: US 2020/0318410 A1
(43) Pub. Date: Oct. 8, 2020

(54) SLIDING SCREEN DOOR SYSTEM

(71) Applicant: SUMMIT PRODUCTS, INC., ALTOONA, IA (US)

(72) Inventors: Trent Quick, Huxley, IA (US); Albert Marasco, Altoona, IA (US); Mike Vinci, Garner, IA (US)

(21) Appl. No.: 16/835,437

(22) Filed: Mar. 31, 2020

Related U.S. Application Data
(60) Provisional application No. 62/829,129, filed on Apr. 4, 2019.

(51) Int. Cl. E05D 15/06; E06B 7/28; B60J 5/06

(52) U.S. Cl. CPC E05D 15/0621; E05Y 2900/531; B60J 5/062; E06B 7/28

(57) ABSTRACT

A sliding screen door system is presented for selectively closing an opening of a vehicle having a fixed screen frame and a sliding screen frame that are connected to one another by a pair of linear slides having an interior member, an exterior member and a center member that facilitate linear sliding of the sliding screen frame relative to the fixed screen frame. The connection of the sliding screen frame to the fixed screen frame with these linear slides suspends the sliding screen frame within the opening of the vehicle thereby eliminating the need for upper and lower rails the encumber the entryway into the vehicle. The sliding screen frame includes a moveable member that accommodates a closing mechanism of the door when it closes thereby allowing the sliding screen frame to be closed when the rear door is closed without causing damage to the sliding screen door.

### CROSS REFERENCE TO RELATED APPLICATIONS

This application claims priority to U.S. Provisional Application No. 62/829,129, which was filed Apr. 4, 2019, the entirety of which is incorporated herein fully by reference.

### FIELD OF THE DISCLOSURE

This disclosure relates to doors. More specifically and without limitation, this disclosure relates to sliding screen door systems.

### OVERVIEW

There are countless forms of screen doors. Screen doors provide dual functionality. Screen doors operate in much the same way that conventional doors operate in that they open and close, thereby allowing or preventing access through an opening in a building or vehicle. Screen doors also allow for generous air flow through the opening, while simultaneously preventing the passage of bugs through the opening, through the use of mesh screen material that forms a portion of the screen door.

Due to their unique properties, screen doors are used in a wide variety of applications including being installed on homes as well as vehicles such as campers. Screen doors are well suited for installation in flat and square applications, such as on buildings or other flat and square applications. However, substantial problems exist when installing existing screen doors in unconventional applications, such as on vehicles that serve as campers having more complex openings and configurations.

Therefore, for all the reasons stated above, and the reasons stated below, there is a need in the art for an improved sliding screen door system that is improves upon the state of the art.

Thus, it is an object of the disclosure to provide a sliding screen door system that improves upon the state of the art.

Another object of the disclosure is to provide a sliding screen door system that may be installed in complex openings.

Yet another object of the disclosure to provide a sliding screen door system that may be installed in vehicles.

Another object of the disclosure is to provide a sliding screen door system that is easy to use.

Yet another object of the disclosure to provide a sliding screen door system that does not require a bottom rail at the opening and closing end.

Another object of the disclosure is to provide a sliding screen door system that does not require a top rail at the opening and closing end.

Yet another object of the disclosure to provide a sliding screen door system that does not require both a bottom rail and a top rail at the opening and closing end.

Another object of the disclosure is to provide a sliding screen door system that does not encumber the entryway of a vehicle.

Yet another object of the disclosure to provide a sliding screen door system that may be installed in a wide variety of vehicles.

Another object of the disclosure is to provide a sliding screen door system that allows for the door of the vehicle to be closed while the sliding screen door is closed.

Yet another object of the disclosure to provide a sliding screen door system that allows the door of the vehicle to be closed while the sliding screen door is open.

Another object of the disclosure is to provide a sliding screen door system that is not damaged or broken when the door of the vehicle is closed when the sliding screen door is closed.

Yet another object of the disclosure to provide a sliding screen door system that is robust.

Another object of the disclosure is to provide a sliding screen door system that is durable.

Yet another object of the disclosure to provide a sliding screen door system that is easy to install.

Another object of the disclosure is to provide a sliding screen door system that is easy to use.

Yet another object of the disclosure is to provide a sliding screen door system that can be used with practically any vehicle that serves as a camper.

Another object of the disclosure is to provide a sliding screen door system that provides a sliding screen frame that does not require connection to a rail at the upper or lower portion of the sliding screen frame.

Yet another object of the disclosure to provide a sliding screen door system that is relatively inexpensive.

Another object of the disclosure is to provide a sliding screen door system that allows the sliding screen door to be curved.

Yet another object of the disclosure to provide a sliding screen door system that allows the sliding screen door to fit complex-shaped openings.

Another object of the disclosure is to provide a sliding screen door system that is aesthetically pleasing.

Yet another object of the disclosure to provide a sliding screen door system that provides a lot of airflow through the opening.

Another object of the disclosure is to provide a sliding screen door system that effectively prevents bugs from passing through the opening.

Yet another object of the disclosure to provide a sliding screen door system that effectively seals the opening.

Another object of the disclosure is to provide a sliding screen door system that provides easy access into and/or out of the vehicle.

Yet another object of the disclosure to provide a sliding screen door system that is high quality.

Another object of the disclosure is to provide a sliding screen door system that can be locked.

These and other objects, features, or advantages of the disclosure will become apparent from the specification, figures and claims.

### SUMMARY OF THE DISCLOSURE

A sliding screen door system is presented for selectively closing an opening of a vehicle having a fixed screen frame and a sliding screen frame that are connected to one another by a pair of linear slides having an interior member, an exterior member and a center member that facilitate linear sliding of the sliding screen frame relative to the fixed screen frame. The connection of the sliding screen frame to the fixed screen frame with these linear slides suspends the sliding screen frame within the opening of the vehicle thereby eliminating the need for upper and lower rails that encumber the entryway into the vehicle. The sliding screen frame includes a moveable member that accommodates a closing mechanism of the door when it closes thereby allowing the sliding screen frame to be closed when the rear door is closed without causing damage to the sliding screen door.

### BRIEF DESCRIPTION OF THE DRAWINGS

FIG. 1 is a side elevation view of a demonstrative vehicle having a rear door that covers an opening that sliding screen door system is used to cover, the view showing the rear door in a closed position;

FIG. 2 is a side elevation view of a demonstrative vehicle having a rear door that covers an opening that sliding screen door system is used to cover, the view showing the rear door in an open position;

FIG. 3 is a side elevation view of a skeletonized demonstrative vehicle having a rear door that covers an opening that sliding screen door system is used to cover, the view showing the rear door removed, the view showing a sliding screen door system having a fixed screen frame and a sliding screen frame attached to the vehicle, the view showing the sliding screen frame in a closed position;

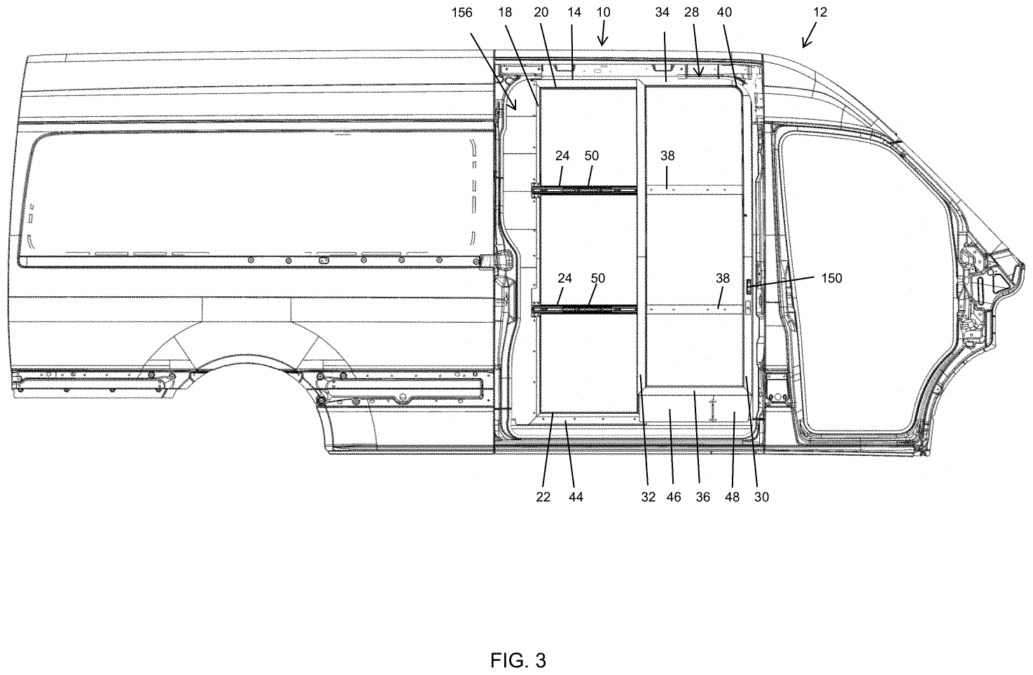

FIG. 4 is a side elevation view of a skeletonized demonstrative vehicle having a rear door that covers an opening that sliding screen door system is used to cover, the view showing the rear door removed, the view showing a sliding screen door system having a fixed screen frame and a sliding screen frame attached to the vehicle, the view showing the sliding screen frame in an open position;

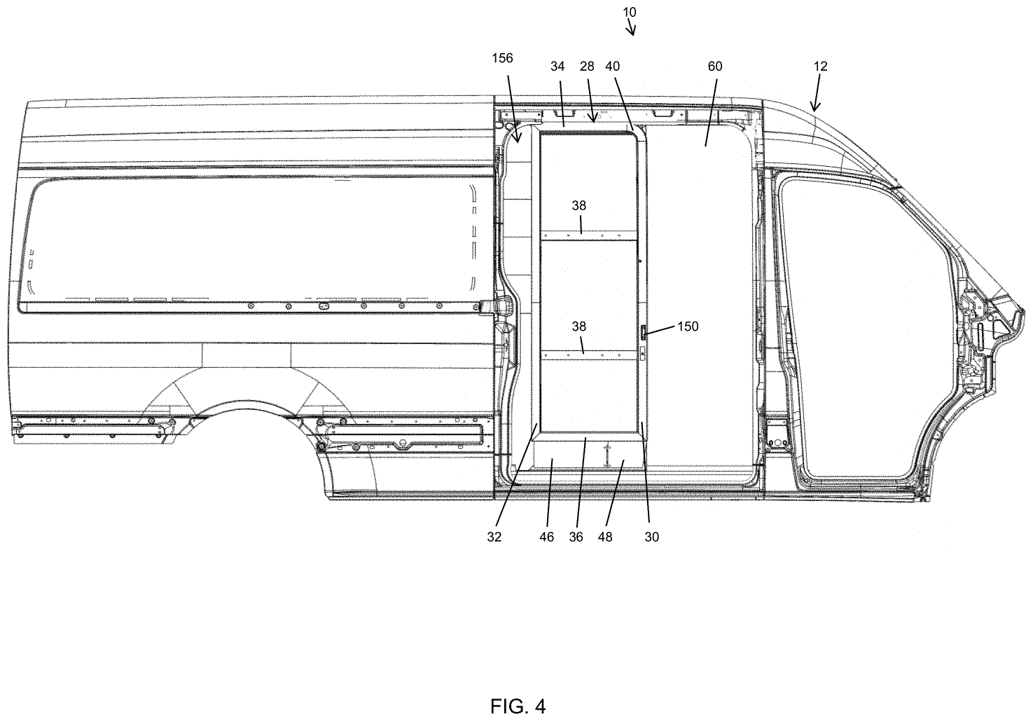

FIG. 5 is a perspective view of a skeletonized demonstrative vehicle having a rear door that covers an opening that sliding screen door system is used to cover, the view showing the rear door removed, the view showing a sliding screen door system having a fixed screen frame and a sliding screen frame attached to the vehicle, the view showing the sliding screen frame in a partially opened/partially closed position;

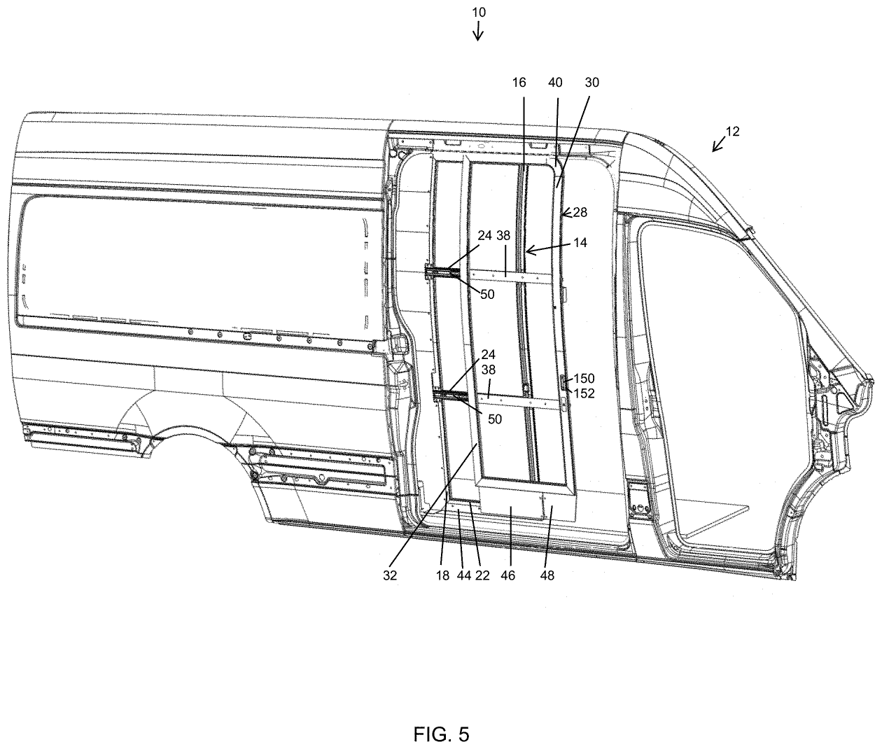

FIG. 6 is a perspective view from the exterior-front side of a sliding screen door system used to cover an opening in a vehicle, the view showing a sliding screen door system having a fixed screen frame and a sliding screen frame, the view showing the sliding screen frame in a closed position;

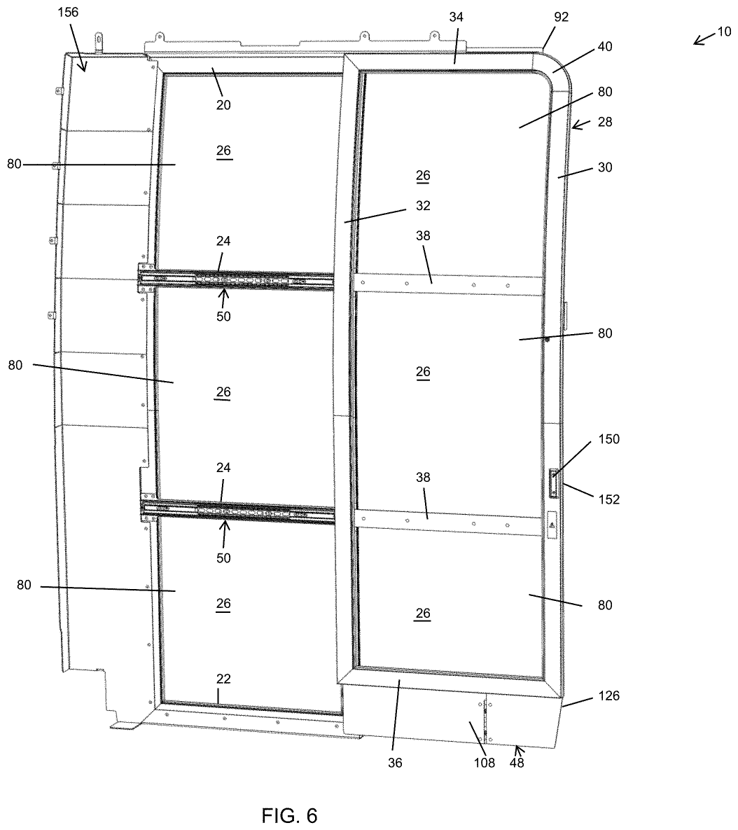

FIG. 7 is a perspective view from the exterior-front side of a sliding screen door system used to cover an opening in a vehicle, the view showing a sliding screen door system having a fixed screen frame and a sliding screen frame, the view showing the sliding screen frame in a partially opened/partially closed position;

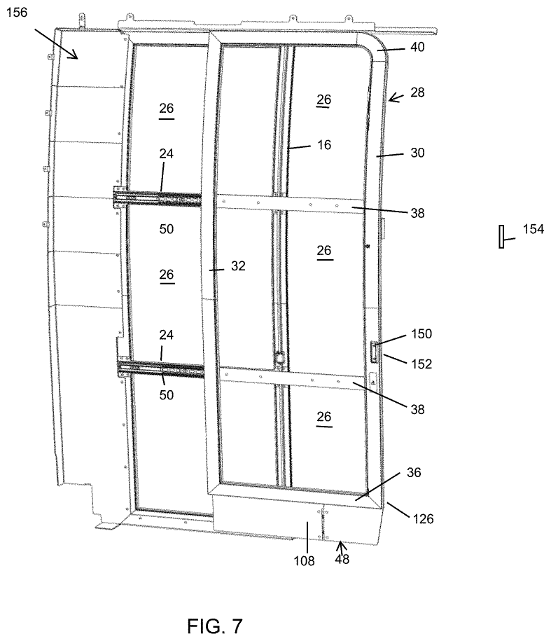

FIG. 8 is a perspective view from the exterior-front side of a sliding screen door system used to cover an opening in a vehicle, the view showing a sliding screen door system having a fixed screen frame and a sliding screen frame, the view showing the sliding screen frame in an open position;

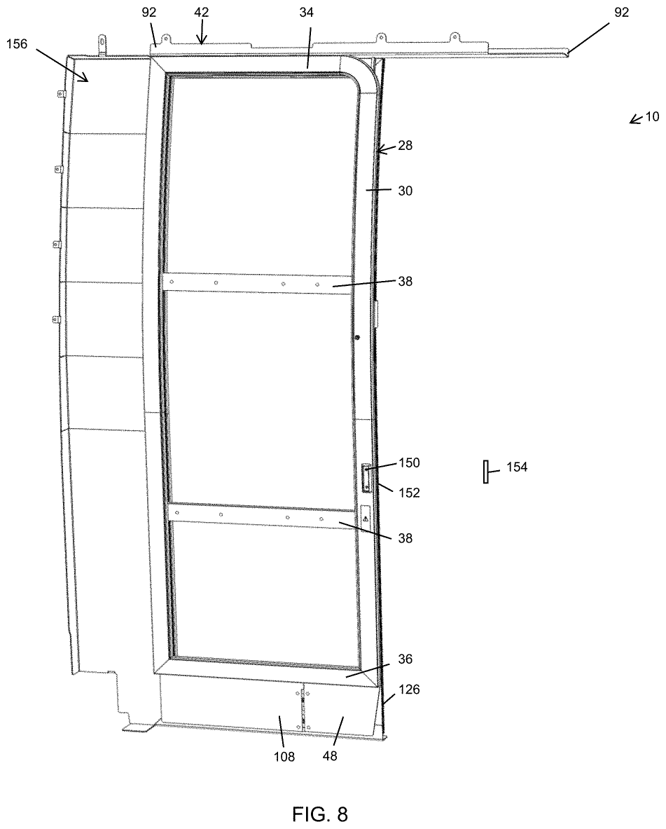

FIG. 9 is a front elevation view of a sliding screen door system used to cover an opening in a vehicle, the view showing a sliding screen door system having a fixed screen frame and a sliding screen frame, the view showing the sliding screen frame and the fixed screen frame having a curved shape that matches the curved contours of the vehicle, the view showing a top rail connected to the top end of the sliding screen door system, the view showing a bottom rail connected to the bottom end of the sliding screen door system;

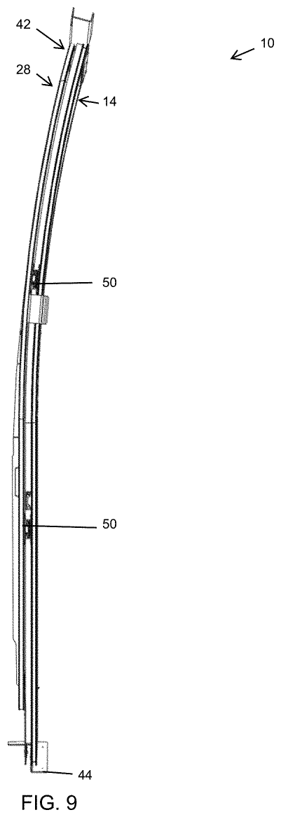

FIG. 10 is a front elevation view of a sliding screen door system used to cover an opening in a vehicle, the view showing a sliding screen door system having a fixed screen frame and a sliding screen frame, the view showing the sliding screen frame and the fixed screen frame having a curved shape that matches the curved contours of the vehicle, the view showing a top rail connected to the top end of the sliding screen door system, the view showing a bottom rail connected to the bottom end of the sliding screen door system;

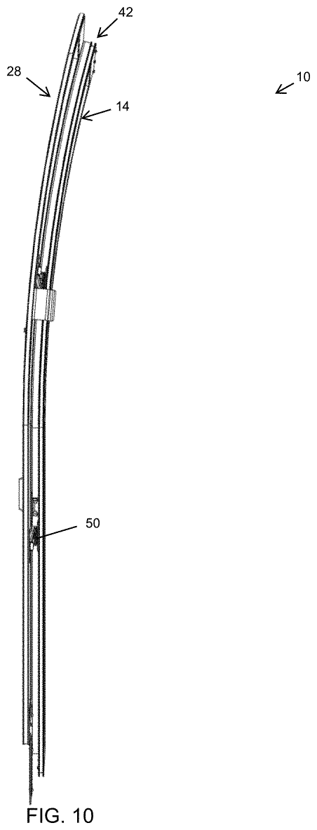

FIG. 11 is a rear elevation view of a sliding screen door system used to cover an opening in a vehicle, the view showing a sliding screen door system having a fixed screen frame and a sliding screen frame, the view showing the sliding screen frame and the fixed screen frame having a curved shape that matches the curved contours of the vehicle, the view showing a top rail connected to the top end of the sliding screen door system, the view showing a bottom rail connected to the bottom end of the sliding screen door system;

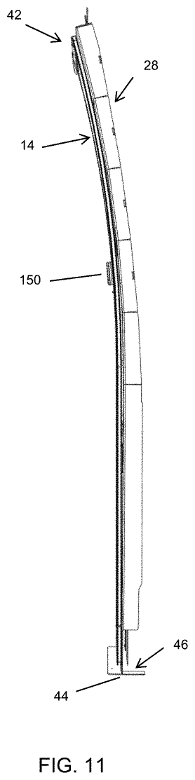

FIG. 12 is a rear elevation view of a sliding screen door system used to cover an opening in a vehicle, the view showing a sliding screen door system having a fixed screen frame and a sliding screen frame, the view showing the sliding screen frame and the fixed screen frame having a curved shape that matches the curved contours of the vehicle;

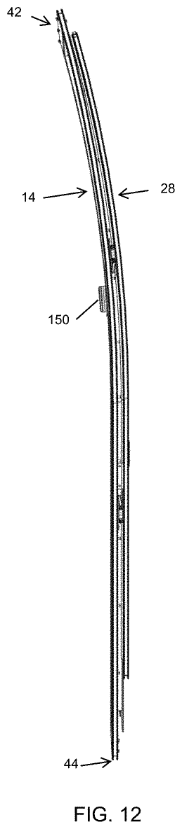

FIG. 13 is a perspective view from the interior-rear side of a sliding screen door system used to cover an opening in a vehicle, the view showing a sliding screen door system having a fixed screen frame and a sliding screen frame, the view showing the sliding screen frame in an open position;

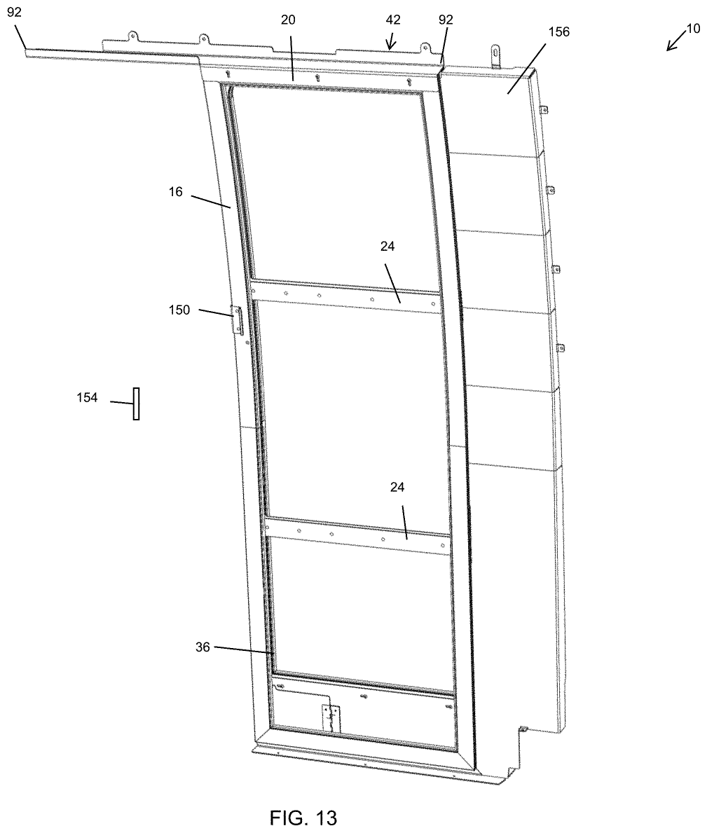

FIG. 14 is a perspective top view of a sliding screen door system used to cover an opening in a vehicle, the view showing a sliding screen door system having a fixed screen frame and a sliding screen frame, the view showing the sliding screen frame in a partially opened/partially closed position;

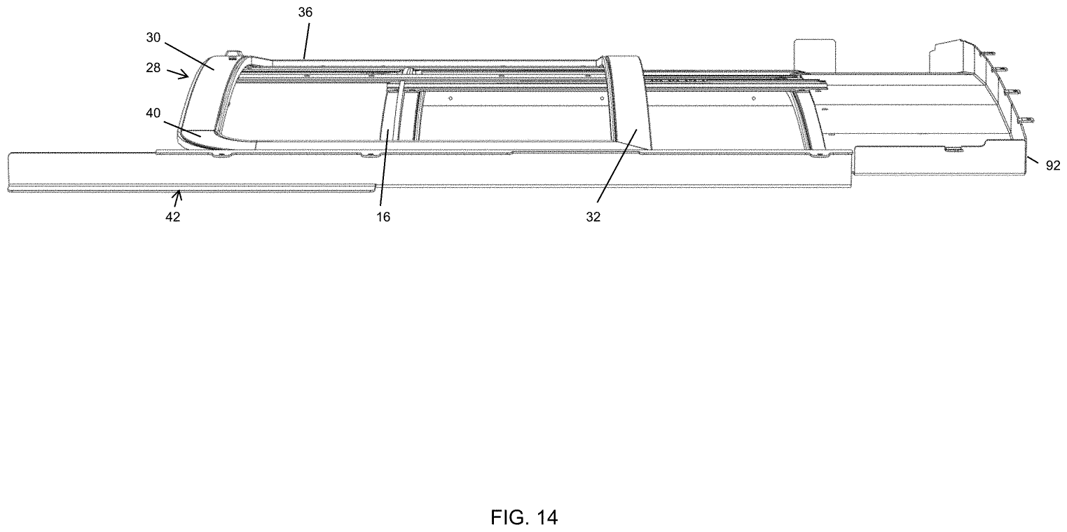

FIG. 15 is a perspective top view of a sliding screen door system used to cover an opening in a vehicle, the view showing a sliding screen door system having a fixed screen frame and a sliding screen frame, the view showing the sliding screen frame in a closed position;

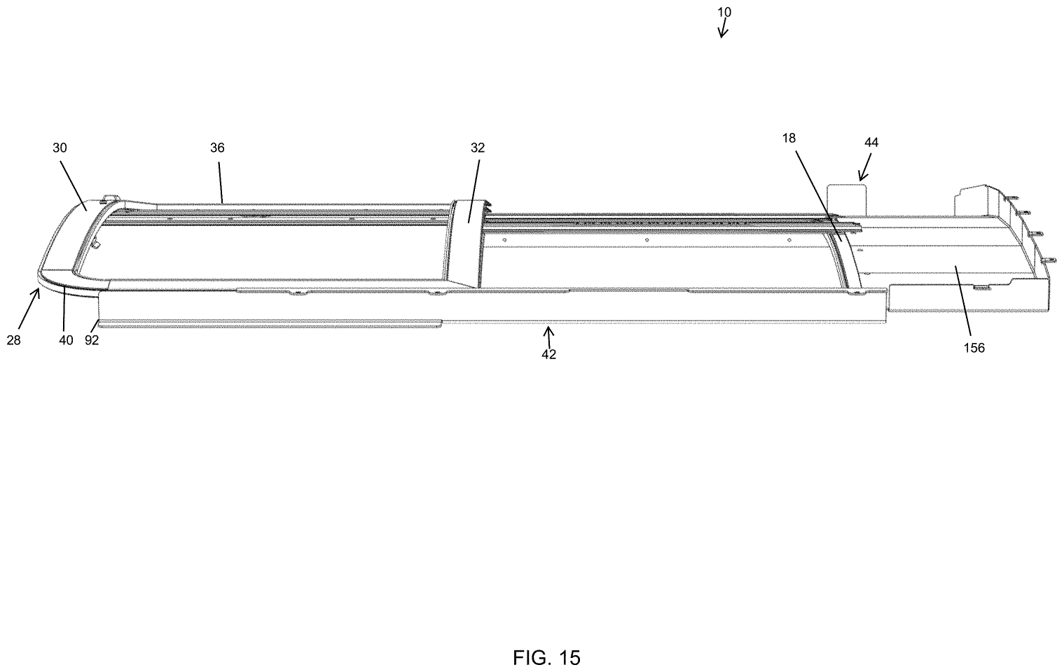

FIG. 16 is a perspective bottom view of a sliding screen door system is used to cover an opening in a vehicle, the view showing a sliding screen door system having a fixed screen frame and a sliding screen frame, the view showing the sliding screen frame in a partially opened/partially closed position;

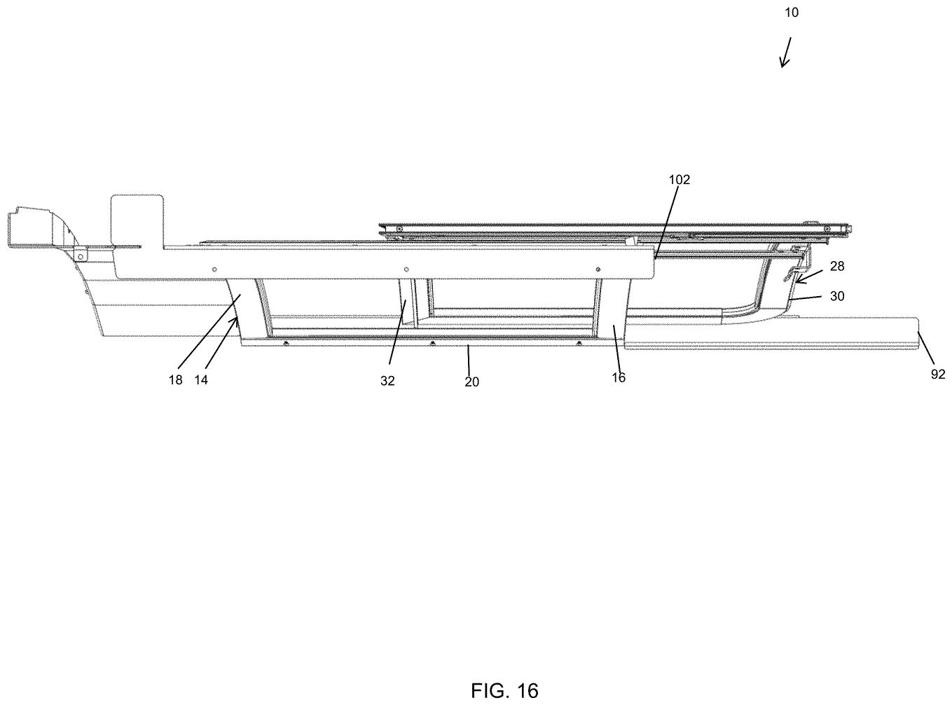

FIG. 17 is a perspective bottom view of a sliding screen door system used to cover an opening in a vehicle, the view showing a sliding screen door system having a fixed screen frame and a sliding screen frame, the view showing the sliding screen frame in a closed position;

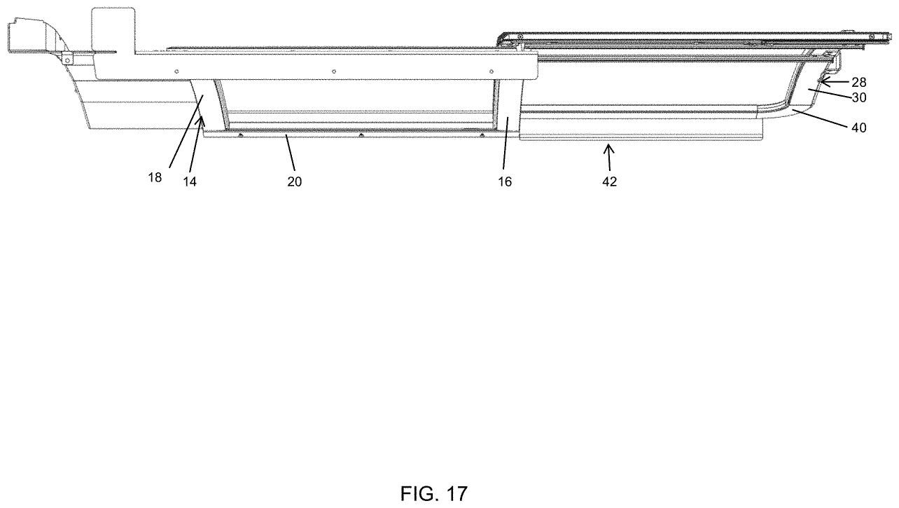

FIG. 18 is a perspective view from the exterior-rear side of a sliding screen door system is used to cover an opening in a vehicle, the view showing the upper rearward end of the sliding screen door system, the view showing the sliding screen frame in a partially opened/partially closed position;

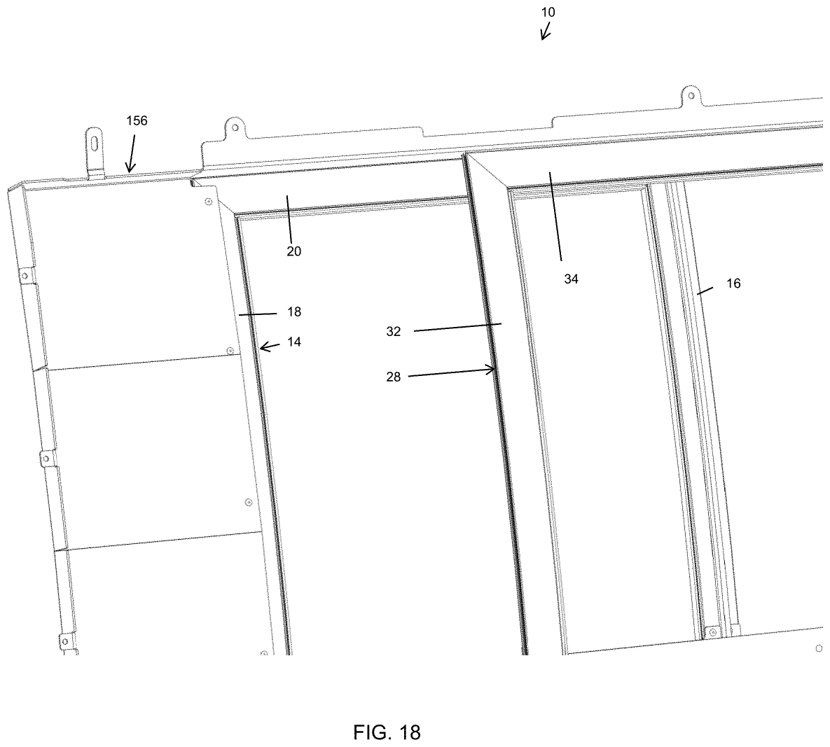

FIG. 19 is perspective view from the exterior-rear side of a sliding screen door system is used to cover an opening in a vehicle, the view showing the upper forward end of the sliding screen door system, the view showing the sliding screen frame in a partially-closed position;

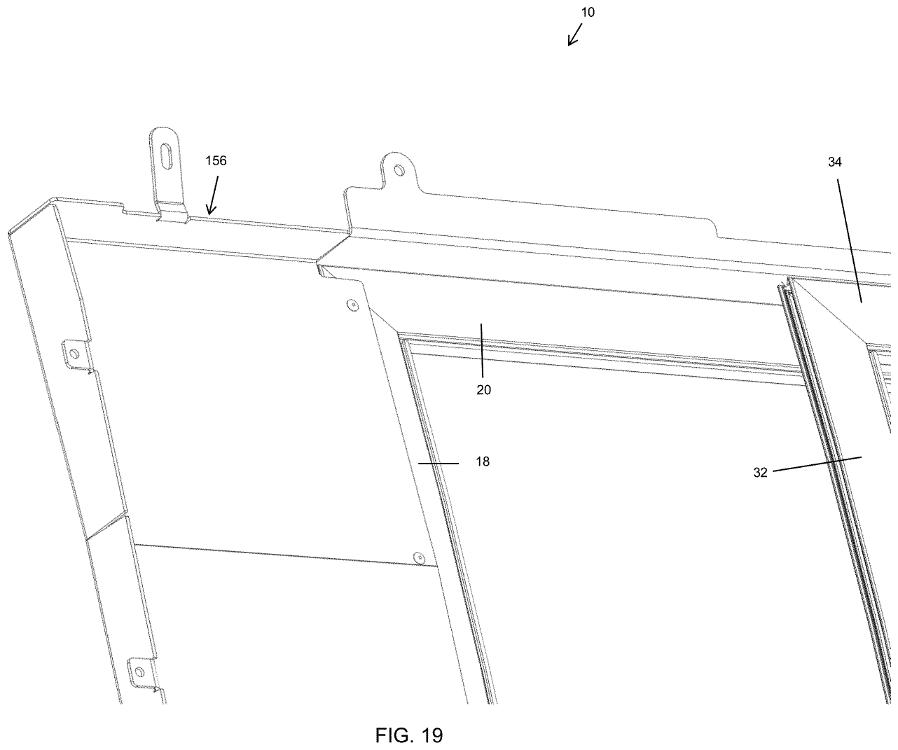

FIG. 20 is perspective view from the exterior-front side of a sliding screen door system is used to cover an opening in a vehicle, the view showing the upper forward end of the sliding screen door system, the view showing the sliding screen frame in a closed position;

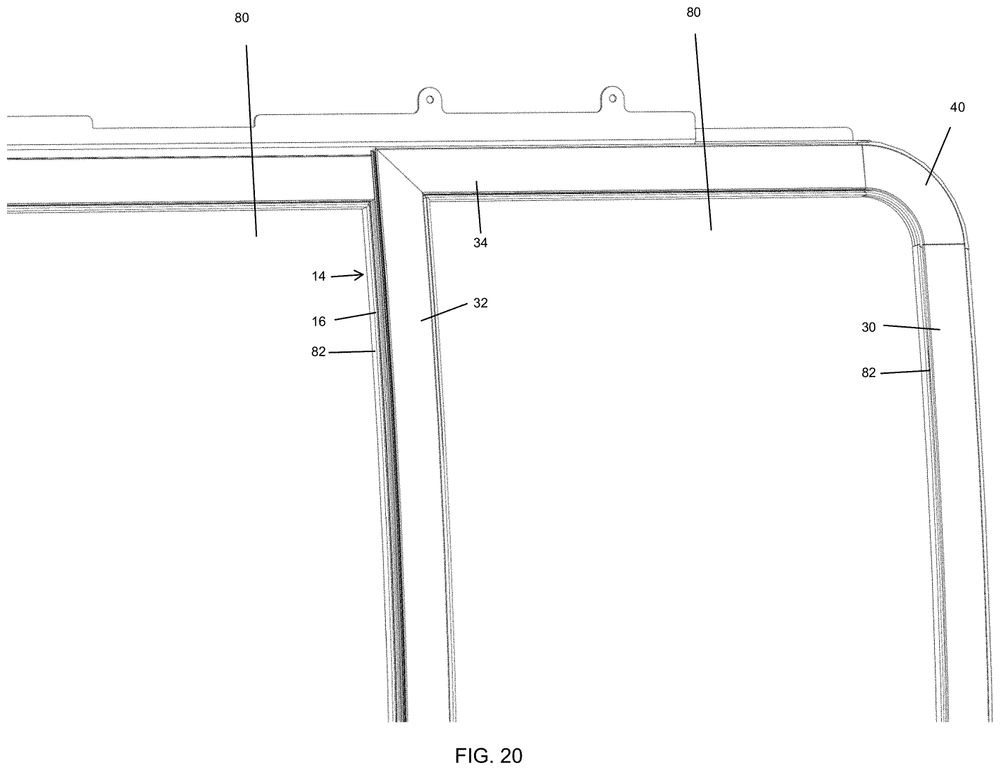

FIG. 21 is a rear elevation section view of a sliding screen door system used to cover an opening in a vehicle, the view showing a sliding screen door system having a fixed screen frame and a sliding screen frame, the view showing the sliding screen frame and the fixed screen frame having a curved shape that matches the curved contours of the vehicle, the view showing a top rail connected to the top end of the sliding screen door system and the upper end of the sliding screen frame positioned within the channel of the top rail, the view showing a sealing member connected to the top end of the sliding screen frame and connecting to the lower surface of the top rail thereby sealing the top end of the sliding screen frame preventing bugs from entering the vehicle;

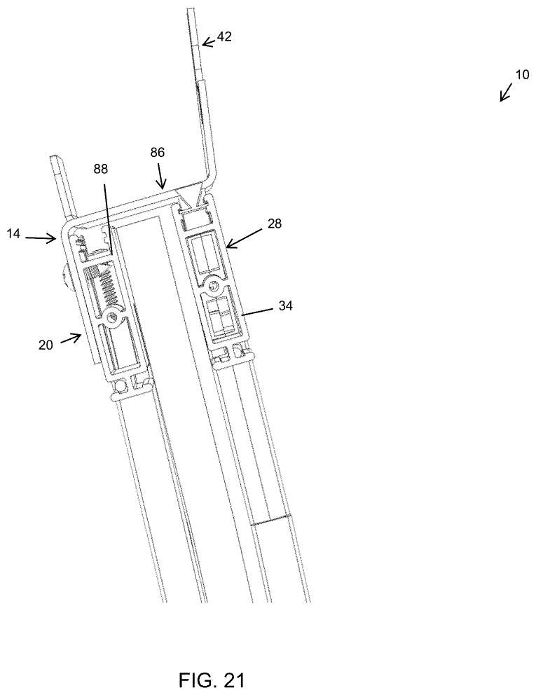

FIG. 22 is a perspective view from the exterior-rear side of the bottom side of a sliding screen door system used to cover an opening in a vehicle, the view showing a sliding screen door system having a fixed screen frame and a sliding screen frame, the view showing the sliding screen frame and the fixed screen frame having a curved shape that matches the curved contours of the vehicle, the view showing the sliding screen frame in a closed position, the view showing a bottom rail connected to the bottom end of the fixed screen frame, the view showing a kick plate connected to the rearward side of the bottom of the sliding screen frame, the view showing a movable member connected to the bottom of the sliding screen frame forward of the kick plate;

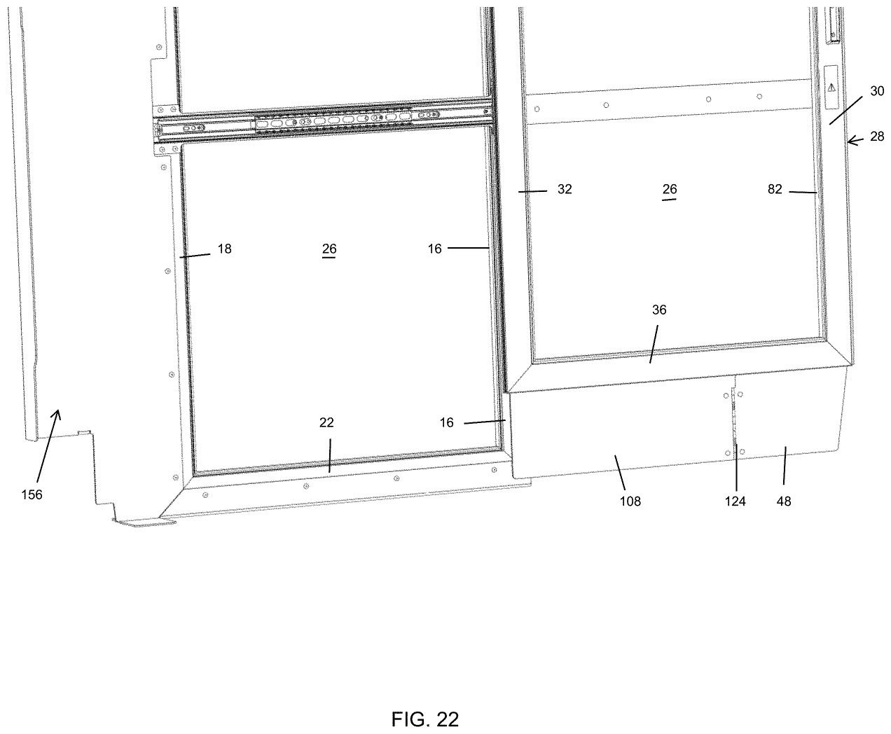

FIG. 23 is a perspective view from the exterior-rear side of the bottom side of a sliding screen door system used to cover an opening in a vehicle, the view showing a sliding screen door system having a fixed screen frame and a sliding screen frame, the view showing the sliding screen frame and the fixed screen frame having a curved shape that matches the curved contours of the vehicle, the view showing the sliding screen frame in a partially open/partially closed position, the view showing a bottom rail connected to the bottom end of the fixed screen frame, the view showing a kick plate connected to the rearward side of the bottom of the sliding screen frame, the view showing a movable member connected to the bottom of the sliding screen frame forward of the kick plate;

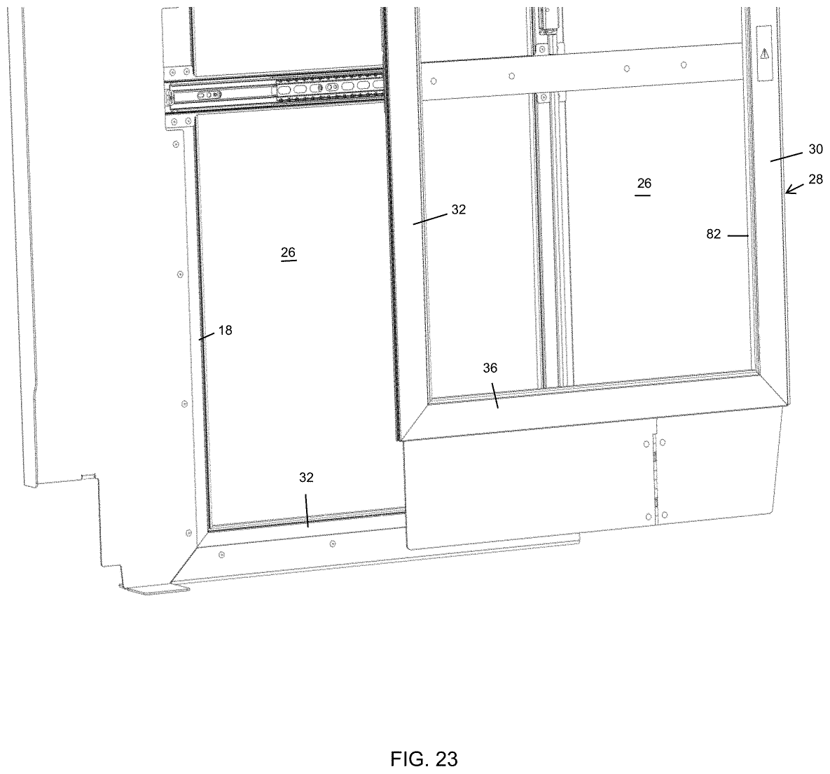

FIG. 24 is a front elevation section view of a sliding screen door system used to cover an opening in a vehicle, the view showing a sliding screen door system having a fixed screen frame and a sliding screen frame, the view showing the sliding screen frame and the fixed screen frame having a curved shape that matches the curved contours of the vehicle, the view showing a bottom rail connected to the bottom end of the sliding screen door system and a kick plate connected to the lower end of the sliding screen frame positioned in front of the bottom rail;

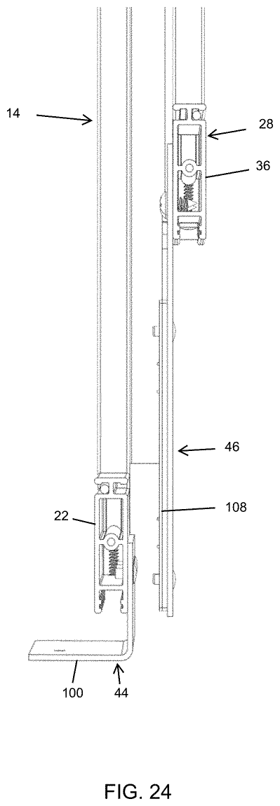

FIG. 25 is a perspective view from the exterior-rear side of the center of a sliding screen door system used to cover an opening in a vehicle, the view showing a sliding screen door system having a fixed screen frame and a sliding screen frame, the view showing the sliding screen frame and the fixed screen frame having a curved shape that matches the curved contours of the vehicle, the view showing the sliding screen frame in a partially open/partially closed position, the view showing linear slides connected to the cross members of the fixed screen frame and the sliding screen frame;

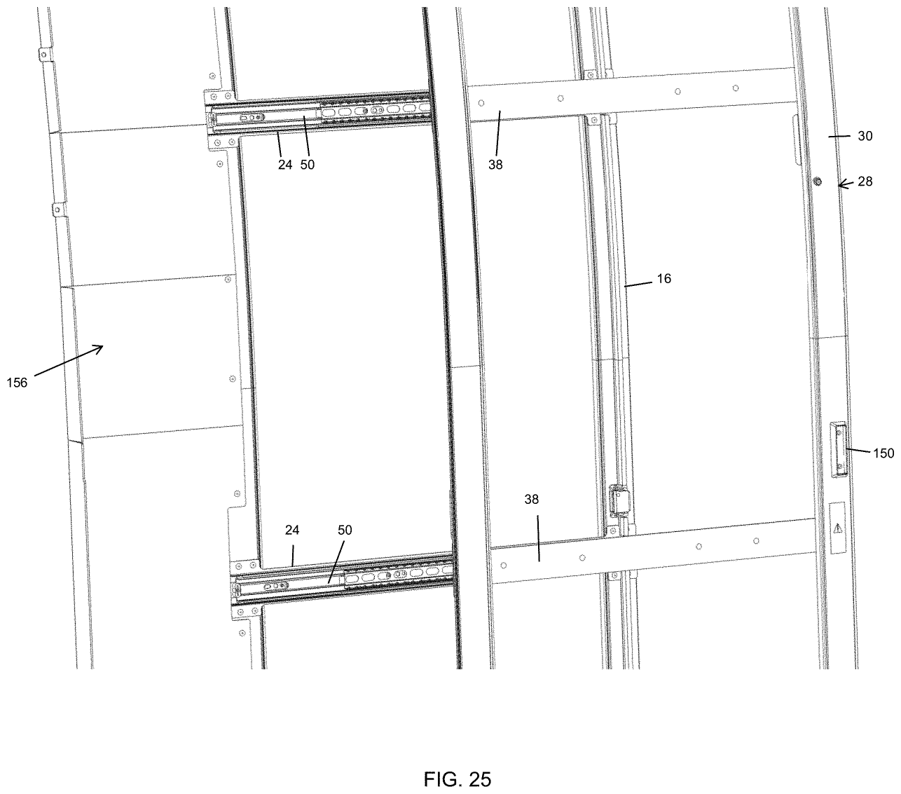

FIG. 26 is a perspective close-up view of a cross member shown in FIG. 23, the view from the exterior-rear side of the center of a sliding screen door system used to cover an opening in a vehicle, the view showing a sliding screen door system having a fixed screen frame and a sliding screen frame, the view showing the sliding screen frame and the fixed screen frame having a curved shape that matches the curved contours of the vehicle, the view showing the sliding screen frame in a partially open/partially closed position, the view showing a linear slide connected to a cross members of the fixed screen frame and the sliding screen frame;

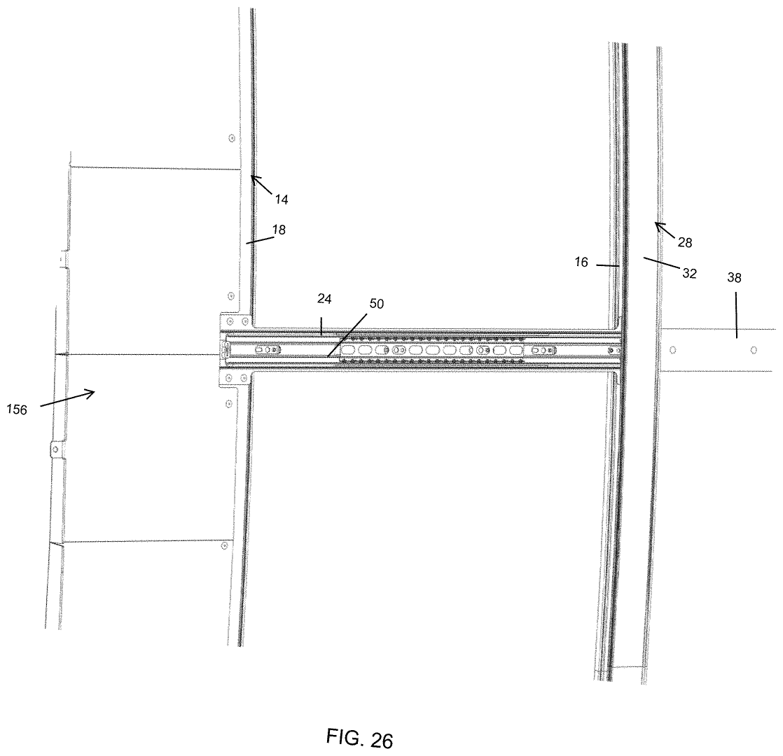

FIG. 27 is a rear elevation cross section view of a sliding screen door system used to cover an opening in a vehicle, the view showing a sliding screen door system having a fixed screen frame and a sliding screen frame, the view showing the sliding screen frame and the fixed screen frame having a curved shape that matches the curved contours of the vehicle, the view showing a linear slide connected to a cross members of the fixed screen frame and the sliding screen frame, the view showing the linear slide having an interior member, an exterior member and a center member that engage and are separated by bearings;

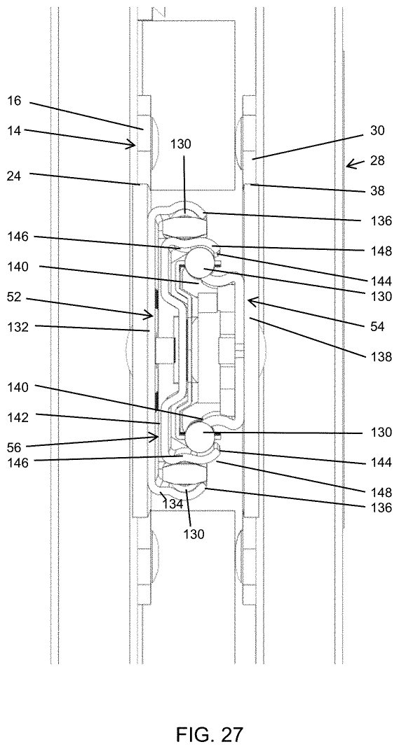

FIG. 28 is a perspective view from the exterior-front side of the center side of a sliding screen door system used to cover an opening in a vehicle, the view showing a sliding screen door system having a fixed screen frame and a sliding screen frame, the view showing the sliding screen frame in a partially-closed position;

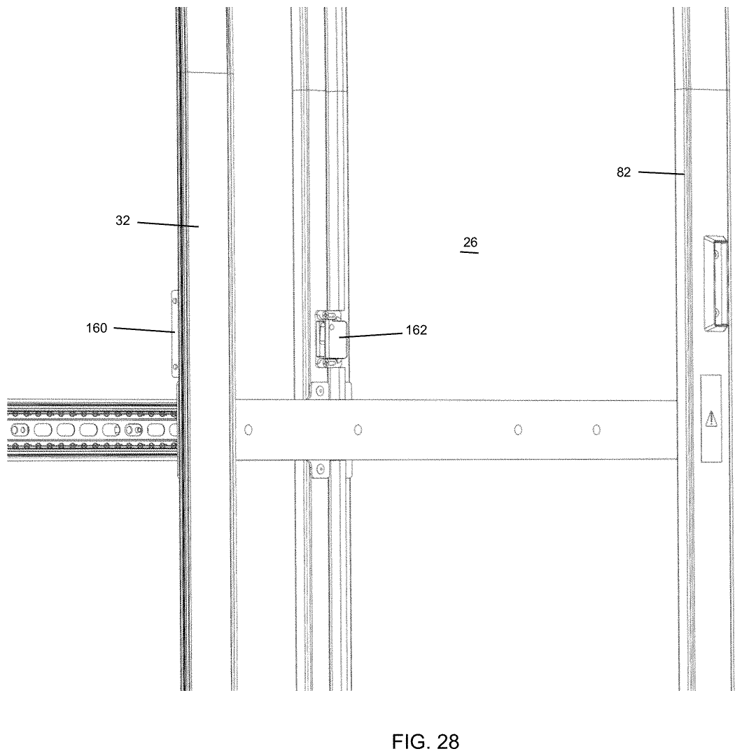

FIG. 29 is a perspective view from the interior side of the top side of a sliding screen door system used to cover an opening in a vehicle, the view showing a sliding screen door system having a fixed screen frame and a sliding screen frame, the view showing the sliding screen frame in a partially-closed position;

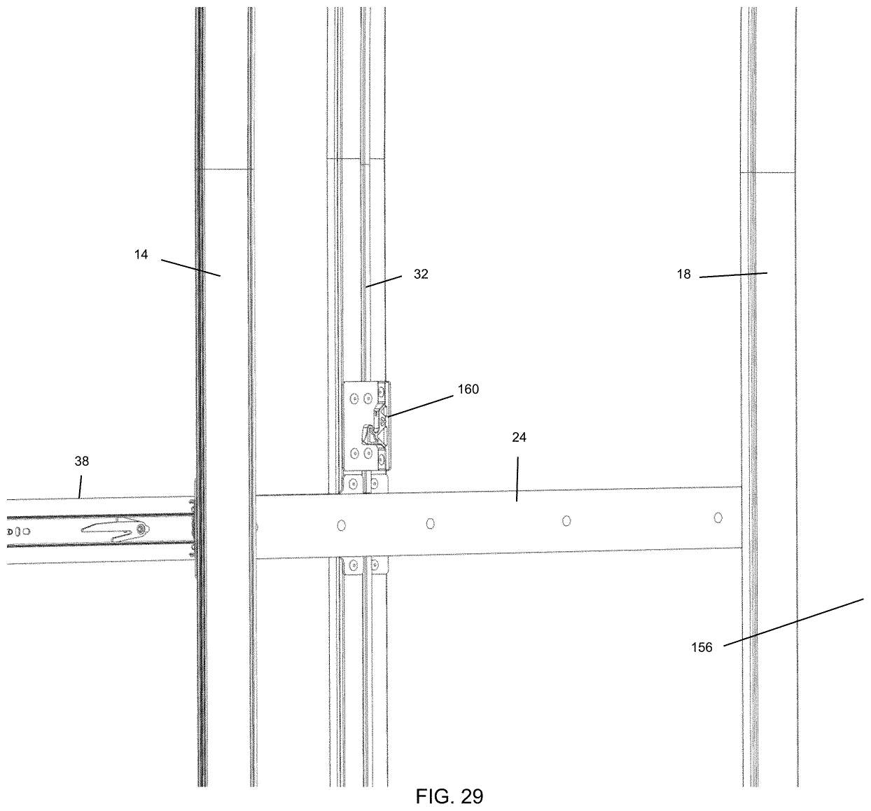

FIG. 30 is a perspective view from the interior-side of the bottom side of a sliding screen door system used to cover an opening in a vehicle, the view showing a sliding screen door system having a fixed screen frame and a sliding screen frame, the view showing the sliding screen frame in a partially-closed position;

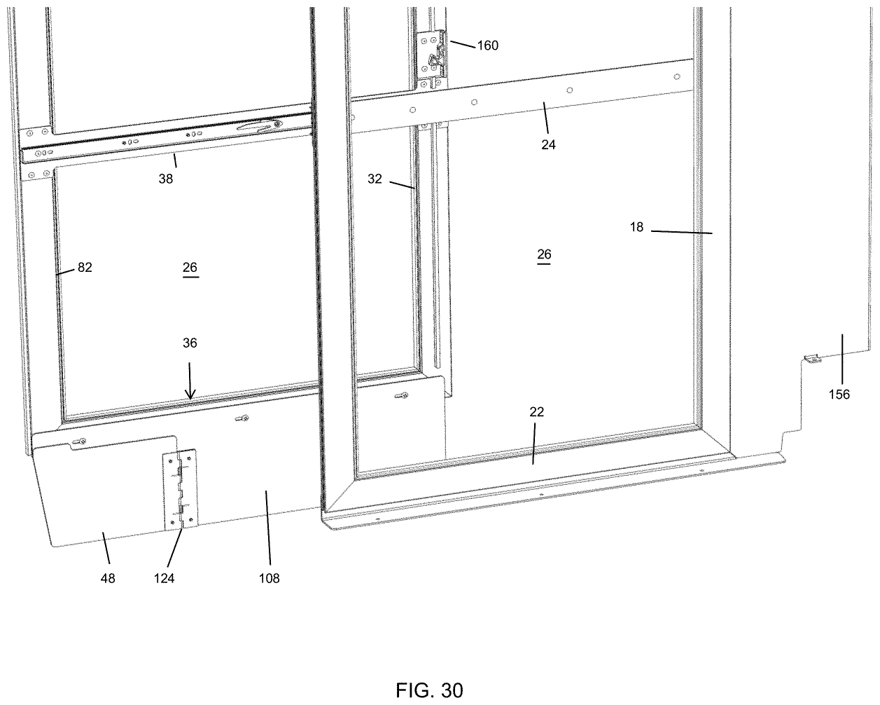

FIG. 31 is a perspective view from the interior-side of the upper side of a sliding screen door system used to cover an opening in a vehicle, the view showing a sliding screen door system having a fixed screen frame and a sliding screen frame, the view showing the sliding screen frame in a partially-closed position;

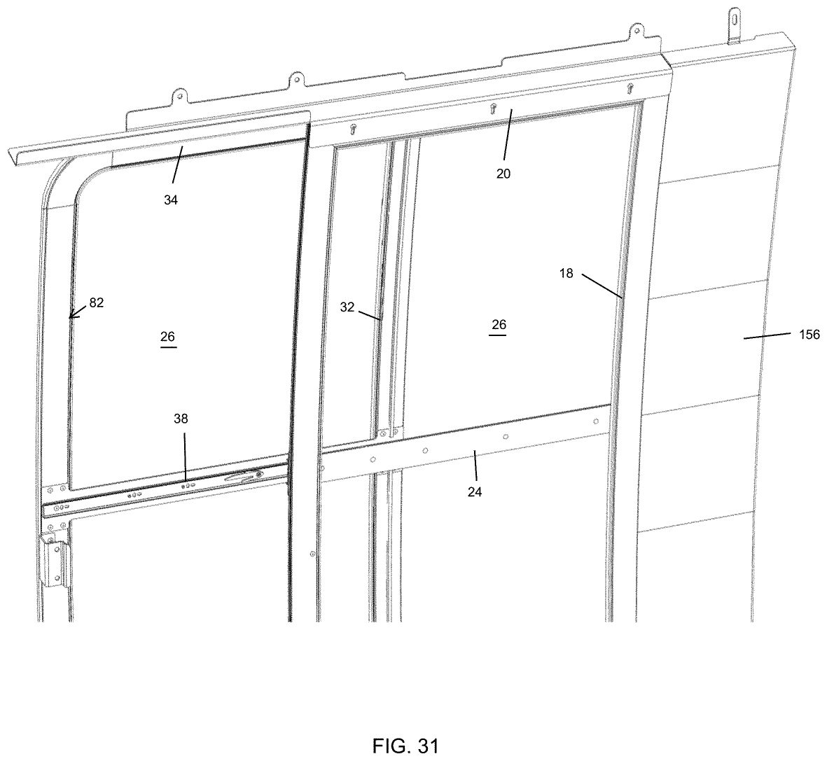

FIG. 32 is a rear elevation section view of a sliding screen door system used to cover an opening in a vehicle, the view showing a sliding screen door system having a fixed screen frame and a sliding screen frame, the view showing the sliding screen frame and the fixed screen frame having a curved shape that matches the curved contours of the vehicle, the view showing a top rail connected to the top end of the sliding screen door system and the upper end of the sliding screen frame positioned within the channel of the top rail, the view showing a sealing member connected to the top end of the sliding screen frame and connecting to the lower surface of the top rail thereby sealing the top end of the sliding screen frame preventing bugs from entering the vehicle;

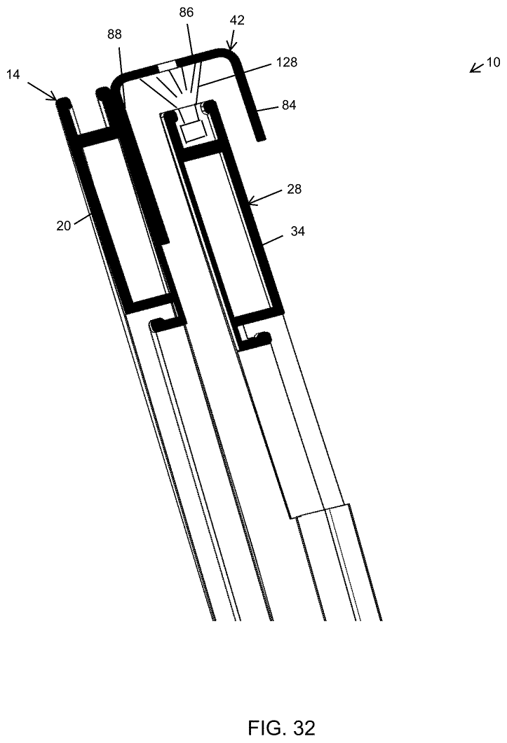

FIG. 33 is a perspective view from the exterior-rear side of the bottom side of a sliding screen door system used to cover an opening in a vehicle, the view showing a sliding screen door system having a fixed screen frame and a sliding screen frame, the view showing the sliding screen frame and the fixed screen frame having a curved shape that matches the curved contours of the vehicle, the view showing the sliding screen frame in a partially open/partially closed position, the view showing a bottom rail connected to the bottom end of the fixed screen frame, the view showing a kick plate connected to the rearward side of the bottom of the sliding screen frame, the view showing a movable member connected to the bottom of the sliding screen frame forward of the kick plate; and

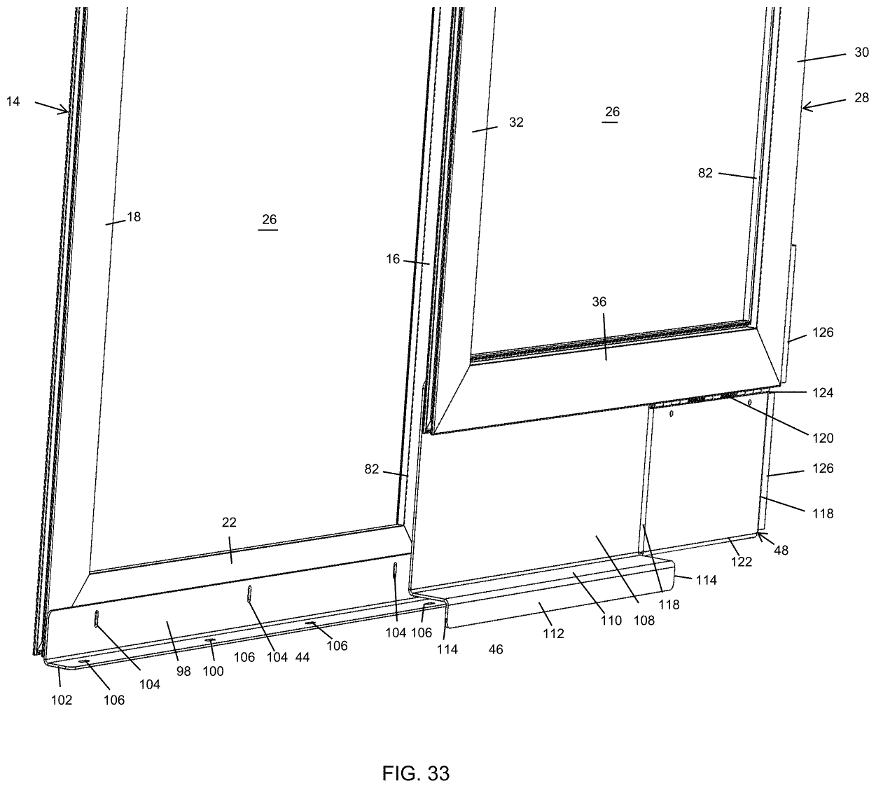

FIG. 34 is a front elevation section view of a sliding screen door system used to cover an opening in a vehicle, the view showing a sliding screen door system having a fixed screen frame and a sliding screen frame, the view showing the sliding screen frame and the fixed screen frame having a curved shape that matches the curved contours of the vehicle, the view showing a bottom rail connected to the bottom end of the sliding screen door system and a kick plate connected to the lower end of the sliding screen frame positioned in front of the bottom rail, the view showing a sealing member connected to the bottom end of the sliding screen frame and connecting to the upper surface of the bottom rail thereby sealing the bottom end of the sliding screen frame preventing bugs from entering the vehicle.

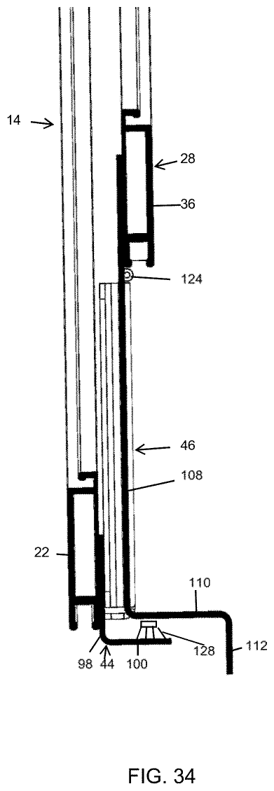

### DETAILED DESCRIPTION OF THE DISCLOSURE

In the following detailed description of the embodiments, reference is made to the accompanying drawings, which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments, which address such objects of the disclosure or invention.

Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure. Moreover, although the disclosed embodiments are primarily described in the context of camper and vehicular applications, the embodiments are not so limited. In is appreciated that the embodiments may be adapted for use in other applications which may be improved by the disclosed structures, arrangements and/or methods.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, the term “or” includes one or more of the associated listed items, such that “A or B” means “A but not B,” and “B but not A.” As used herein, the term “and” includes all combinations of one or more of the associated listed items, such that “A and B” means “A as well as B.” The use of “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof.

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments or methods.

Similarly, the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

### System:

In one or more embodiments of the disclosure, a sliding screen door system is presented for selectively closing an opening of a vehicle having a fixed screen frame and a sliding screen frame that are connected to one another by a pair of linear slides having an interior member, an exterior member and a center member that facilitate linear sliding of the sliding screen frame relative to the fixed screen frame. The connection of the sliding screen frame to the fixed screen frame with these linear slides suspends the sliding screen frame within the opening of the vehicle thereby eliminating the need for upper and lower rails that encumber the entryway into the vehicle. The sliding screen frame includes a moveable member that accommodates a closing mechanism of the door when it closes thereby allowing the sliding screen frame to be closed when the rear door is closed without causing damage to the sliding screen door.

With reference to the figures, for example, a sliding screen door system 10 (or screen door system 10 or simply system 10) is presented that is used in association with a vehicle 12. In the arrangement shown, as one example, the sliding screen door system 10 includes: a fixed screen frame 14 having front member 16, a rear member 18, a top member 20, a bottom member 22, at least one cross member 24, and screen material 26, among other components and features; a sliding screen frame 28 having a front member 30, a rear member 32, a top member 34, a bottom member 36, at least one cross member 38 and a corner section 40, among other components and features; a top rail 42; a bottom rail 44; a kick plate 46 having a movable member 48; at least one linear slide 50 having an internal member 52, an external member 54 and a center member 56, among other components, features, systems and configurations as is shown, claimed and/or described herein.

### Vehicle:

In the arrangement shown, as one example, sliding screen door system 10 is used in association with a vehicle 12. Vehicle 12 may be formed of any suitable size, shape, and design and is configured to facilitate transportation, storage, and/or occupancy. While a vehicle 12 is shown and described herein, the use of sliding screen door system 10 on vehicle 12 is only one of countless examples of use which may include use on homes, buildings, boats, trailers, or any other structure or device that may benefit from a screened access and/or egress.

In the arrangement shown, as one example, vehicle 12 is what is known as a Mercedes “Sprinter” van which is known for being used for a wide variety of uses such as being small campers, utility vehicle, and work vehicles, among a great number of other uses. However, any other make, model, year or type of vehicle is hereby contemplated for use and reference to and depiction of a Mercedes Sprinter van is only one example.

In the arrangement shown, as one example, vehicle 12 includes a rear door 58, which in the arrangement shown, as one example, is on the passenger side of the vehicle 12. However, all of the teaching presented herein is equally applicable to a rear door 58 on the opposite, or driver side, of vehicle 12 by mirroring and/or flipping the arrangement of parts and components.

In the arrangement shown, as one example, rear door 58 covers an opening 60 having a bottom edge or door sill 62, a top edge 64, a rear edge 66 and a forward edge 68. In the arrangement shown, as one example, when viewed from the side, opening 60 is generally square or rectangular in shape. However, any other size, shape, or design is hereby contemplated for opening 60.

In the arrangement shown, as one example, a step 70 is positioned just inward of door sill 62 that steps up to a raised platform or floor 72 within vehicle 12. In the arrangement shown, as one example, rear door 58 rides upon an top rail 74 positioned adjacent the top edge 64 of opening 60 and a bottom rail 76 positioned adjacent the door sill 62. In the arrangement shown, as one example, rear door 58 includes a closing mechanism 78 positioned at the lower forward edge of rear door 66 as well as the upper forward edge of rear door 58 that helps to facilitate the inward motion of rear door 58 at or near the point rear door 58 is fully closed. In the arrangement shown, as one example, the closing mechanism 78 positioned at the upper forward edge of rear door 58 connects to top rail 74 and the closing mechanism 78 positioned at the lower edge of rear door 58 connects to bottom rail 76.

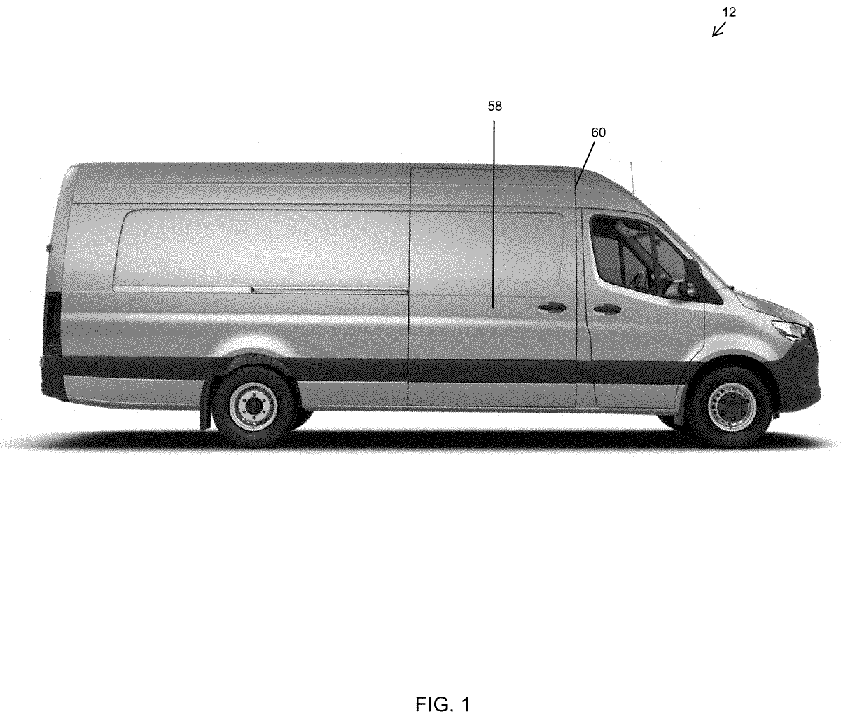

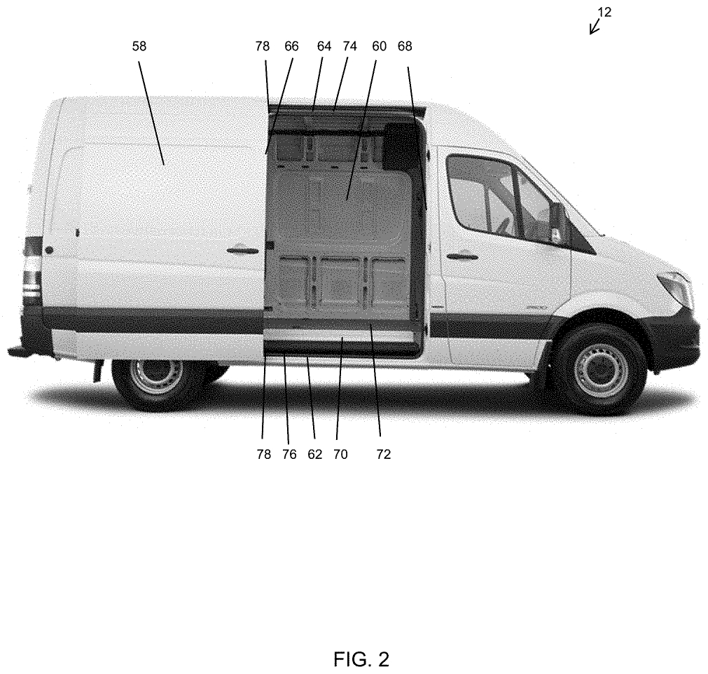

Rear door 58 moves between a closed position, shown in FIG. 1, wherein rear door 58 closes opening 60 and an open position, shown in FIG. 2, wherein rear door 58 moves rearward of opening 60. In the arrangement shown, as one example, sliding screen door system 10 covers opening 60.

### Fixed Screen Frame:

In the arrangement shown, as one example, sliding screen door system 10 includes a fixed screen frame 14. Fixed screen frame 14 may be formed of any suitable size, shape, and design and is configured to be rigidly attached to vehicle 12 in a stationary manner and thereby covering a portion of opening 60. Fixed screen frame 14 is also configured to support sliding screen frame 28.

In the arrangement shown, as one example, fixed screen frame 14 includes a front member 16, a rear member 18, a top member 20, a bottom member 22, at least one cross member 24, and screen material 26, among other components and features as is described herein.

In one arrangement, fixed screen frame 14 is largely formed of a light but strong metallic material such as an extruded aluminum or aluminum alloy material that is painted, anodized, powder coated or otherwise provided with a surface treatment or covering that provides an aesthetically pleasing appearance that is pleasant to the touch. Fixed screen frame 14 may be formed of any other material such as any other metallic material, such as steel, iron, or any other metal or alloy, alternatively a plastic, composite or any other non-metallic material may be used, or alternatively any combination of these materials may be used such as a combination of non-metallic material with metallic material.

### Front Member:

Front member 16 is formed of any suitable size, shape, and design and is configured to form the rigid support structure of the front edge of fixed screen frame 14. In the arrangement shown, as one example, front member 16 is formed of an elongated generally rectangular shaped member that has a width (when viewed from the exterior side or interior side) that is wider than its thickness (when viewed from the front side or rear side). In the arrangement shown, as one example, front member 16, when viewed from an interior side or an exterior side, is a generally straight elongated frame member. In the arrangement shown, as one example, front member 16, when viewed from a forward side or a rearward side, is a generally curved elongated frame member that curves in a concave manner toward the interior of vehicle 12.

In the arrangement shown, as one example, the upper end of front member 16 connects to the forward end of top member 20, and similarly, the lower end of front member 16 connects to the forward end of bottom member 22. In the arrangement shown, as one example, the top end of front member 16 connects to the forward end of top member 20 in a 45-degree intersection.

Similarly, in the arrangement shown, as one example, the bottom end of front member 16 connects to the forward end of bottom member 22 in a 45-degree intersection. Using a 45-degree intersection, also known as a picture frame joint, provides a clean corner and a strong joint with an increased surface area of contact between joined components. However, any other form of a joint is hereby contemplated for use such as a butt joint, a square joint or any other joint. In one arrangement, front member 16 is connected to top member 20 and bottom member 22 by welding. However, any other manner, method or means of connecting two components together is hereby contemplated for use such as screwing, bolting, gluing, adhering, friction fitting, using interlocking members, using fasteners, riveting, or the like or any combination thereof. Alternatively, fixed screen frame 14 is formed of a single solid and unitary component that is formed by molding, casting, machining or otherwise.

In the arrangement shown, as one example, front member 16 extends in a generally parallel spaced manner to rear member 18. In the arrangement shown, as one example, front member 16 extends in a generally perpendicular manner to top member 20 and bottom member 22. However, any other arrangement is hereby contemplated for use.

Rear Member: Rear member 18 is formed of any suitable size, shape, and design and is configured to form the rigid support structure of the rear edge of fixed screen frame 14. In the arrangement shown, as one example, rear member 18 is formed of an elongated generally rectangular shaped member that has a width (when viewed from the exterior side or interior side) that is wider than its thickness (when viewed from the front side or rear side). In the arrangement shown, as one example, rear member 18, when viewed from an interior side or an exterior side, is a generally straight elongated frame member. In the arrangement shown, as one example, rear member 18, when viewed from a forward side or a rearward side, is a generally curved elongated frame member that curves in a concave manner toward the interior of vehicle 12.

In the arrangement shown, as one example, the upper end of rear member 18 connects to the rearward end of top member 20, and similarly, the lower end of rear member 18 connects to the rearward end of bottom member 22. In the arrangement shown, as one example, the top end of rear member 18 connects to the rearward end of top member 20 in a 45-degree intersection. Similarly, in the arrangement shown, as one example, the bottom end of rear member 18 connects to the rearward end of bottom member 22 in a 45-degree intersection. Using a 45-degree intersection, also known as a picture frame joint, provides a clean corner and a strong joint with an increased surface area of contact between joined components. However, any other form of a joint is hereby contemplated for use such as a butt joint, a square joint or any other joint. In one arrangement, rear member 18 is connected to top member 20 and bottom member 22 by welding. However, any other manner, method or means of connecting two components together is hereby contemplated for use such as screwing, bolting, gluing, adhering, friction fitting, using interlocking members, using fasteners, riveting, or the like or any combination thereof.

In the arrangement shown, as one example, rear member 18 extends in a generally parallel spaced manner to front member 16. In the arrangement shown, as one example, rear member 18 extends in a generally perpendicular manner to top member 20 and bottom member 22. However, any other arrangement is hereby contemplated for use.

In one arrangement, rear member 18 is connected to a cabinet, wall or other structural member connected to vehicle 12 at the rear edge 66 of opening 60. In one arrangement, rear member 18 is connected to this cabinet, wall or other structural member connected to vehicle 12 by screwing, bolting, gluing, adhering, friction fitting, using interlocking members, using fasteners, riveting, or the like or any combination thereof. In one or more embodiments, rear member 18 may be connected to a cabinet, wall or other structural member connected to vehicle 12 by an extension member 156 configured and arranged to extend from the rear member 18 to a cabinet, wall or other structural member connected to vehicle 12. The extension member 156 may be connected to the rear member 18 and the vehicle 12 and extend from the rear member 18 to a cabinet, wall or other structural member connected to vehicle 12 by screwing, bolting, gluing, adhering, friction fitting, using interlocking members, using fasteners, riveting, or the like or any combination thereof.

Top Member: Top member 20 is formed of any suitable size, shape, and design and is configured to form the rigid support structure of the top edge of fixed screen frame 14. In the arrangement shown, as one example, top member 20 is formed of an elongated generally rectangular shaped member that has a width (when viewed from the exterior side or interior side) that is wider than its thickness (when viewed from the front side or rear side). In the arrangement shown, as one example, top member 20, when viewed from an interior side or an exterior side, is a generally straight elongated frame member. In the arrangement shown, as one example, top member 20, when viewed from a forward side or a rearward side, is a generally straight elongated frame member.

In the arrangement shown, as one example, the forward end of top member 20 connects to the top end of front member 16, and similarly, the rearward end of top member 20 connects to the top end of rear member 18. In the arrangement shown, as one example, the forward end of top member 20 connects to the top end of front member 16 in a 45-degree intersection. Similarly, in the arrangement shown, as one example, the rearward end of top member 20 connects to the top end of rear member 18 in a 45-degree intersection. Using a 45-degree intersection, also known as a picture frame joint, provides a clean corner and a strong joint with an increased surface area of contact between joined components. However, any other form of a joint is hereby contemplated for use such as a butt joint, a square joint or any other joint. In one arrangement, top member 20 is connected to front member 16 and rear member 18 by welding. However, any other manner, method or means of connecting two components together is hereby contemplated for use such as screwing, bolting, gluing, adhering, friction fitting, using interlocking members, using fasteners, riveting, or the like or any combination thereof.

In the arrangement shown, as one example, top member 20 extends in a generally parallel spaced manner to bottom member 22. In the arrangement shown, as one example, top member 20 extends in a generally perpendicular manner to front member 16 and rear member 18. However, any other arrangement is hereby contemplated for use.

Bottom Member: Bottom member 22 is formed of any suitable size, shape, and design and is configured to form the rigid support structure of the bottom edge of fixed screen frame 14. In the arrangement shown, as one example, bottom member 22 is formed of an elongated generally rectangular shaped member that has a width (when viewed from the exterior side or interior side) that is wider than its thickness (when viewed from the front side or rear side). In the arrangement shown, as one example, bottom member 22, when viewed from an interior side or an exterior side, is a generally straight elongated frame member. In the arrangement shown, as one example, bottom member 22, when viewed from a forward side or a rearward side, is a generally straight elongated frame member.

In the arrangement shown, as one example, the forward end of bottom member 22 connects to the bottom end of front member 16, and similarly, the rearward end of bottom member 22 connects to the bottom end of rear member 18. In the arrangement shown, as one example, the forward end of bottom member 22 connects to the bottom end of front member 16 in a 45-degree intersection. Similarly, in the arrangement shown, as one example, the rearward end of bottom member 22 connects to the bottom end of rear member 18 in a 45-degree intersection. Using a 45-degree intersection, also known as a picture frame joint, provides a clean corner and a strong joint with an increased surface area of contact between joined components. However, any other form of a joint is hereby contemplated for use such as a butt joint, a square joint or any other joint. In one arrangement, bottom member 22 is connected to front member 16 and rear member 18 by welding. However, any other manner, method or means of connecting two components together is hereby contemplated for use such as screwing, bolting, gluing, adhering, friction fitting, using interlocking members, using fasteners, riveting, or the like or any combination thereof.

In the arrangement shown, as one example, bottom member 22 extends in a generally parallel spaced manner to top member 20. In the arrangement shown, as one example, bottom member 22 extends in a generally perpendicular manner to front member 16 and rear member 18. However, any other arrangement is hereby contemplated for use.

Cross Members: Cross members 24 may be formed of any suitable size, shape, and design and is configured to form the rigid support structure of fixed screen frame 14 that extends across the hollow interior of fixed screen frame 14 and connects front member 16 and rear member 18. In the arrangement shown, as one example, a pair of cross members 24 connect opposing front member 16 and rear member 18. However, any number of cross members 24 are hereby contemplated for use such as none, one, two, three, four, five, six, seven, eight, nine, ten, or more. In the arrangement shown, as one example, the upper cross member 24 is positioned approximately one third of the way down from top member 20 and the lower cross member 24 is positioned at approximately two thirds of the way down from top member 20. However, any other placement and arrangement is hereby contemplated for use.

In the arrangement shown, as one example, cross members 24 are formed of an elongated generally rectangular shaped member that has a width (when viewed from the exterior side or interior side) that is wider than its thickness (when viewed from the front side or rear side). In the arrangement shown, as one example, cross members 24, when viewed from an interior side or an exterior side, are generally straight elongated frame members. In the arrangement shown, as one example, cross members 24, when viewed from a forward side or a rearward side, are a generally straight elongated frame member.

In the arrangement shown, as one example, the forward end of cross members 24 connect to the rearward side of front member 16, and similarly, the rearward end of cross members 24 connect to the forward side of rear member 18. In the arrangement shown, as one example, the forward end of cross members 24 connect to the rearward side end of front member 16 in a 90-degree intersection. Similarly, in the arrangement shown, as one example, the rearward end of cross members 24 connect to the forward end of rear member 18 in a 90-degree intersection. However, any other form of a joint is hereby contemplated for use such as a butt joint, a square joint or any other joint. In one arrangement, cross members 24 are connected to front member 16 and rear member 18 by welding. However, any other manner, method or means of connecting two components together is hereby contemplated for use such as screwing, bolting, gluing, adhering, friction fitting, using interlocking members, using fasteners, riveting, or the like or any combination thereof.

In the arrangement shown, as one example, cross members 24 extend in a generally parallel spaced manner to top member 20 and bottom member 22. In the arrangement shown, as one example, cross members 24 extend in a generally perpendicular manner to front member 16 and rear member 18. However, any other arrangement is hereby contemplated for use.

Screen Material: In the arrangement shown, as one example, where two cross members 24 are used, fixed screen frame 14 is divided into three sections 80 or openings that are covered by screen material 26.

In the arrangement shown, as one example, the upper section 80 is defined between the rear surface of front member 16, the forward surface of rear member 18, the bottom surface of top member 20 and the top surface of the upper cross member 24. In the arrangement shown, as one example, the lower section 80 is defined between the rear surface of front member 16, the forward surface of rear member 18, the bottom surface of the lower cross member 24 and the top surface of the bottom cross member 24. In the arrangement shown, as one example, the middle section 80 is defined between the rear surface of front member 16, the forward surface of rear member 18, the bottom surface of the upper cross member 24 and the upper surface of the lower cross member 24.

Screen material 26 is formed of any suitable size, shape, and design and is configured to cover and close each section 80 in fixed screen frame 14 while allowing air to freely pass through these openings while simultaneously preventing bugs from entering vehicle 12. In the arrangement shown, as one example, screen material 26 is formed of a mesh material. However, any other form of material is hereby contemplated for use.

In the arrangement shown, as one example, screen material 26 is stretched across sections 80 and is secured to fixed screen frame 14 in a channel 82 in fixed screen frame 14 adjacent the opening of each section 80. In the arrangement shown, as one example, channel 82 extends in a continuous manner around the entire periphery of each section 80. In this way, screen material 26 may be secured to fixed screen frame 14 around the entire peripheral edge of each section 80 thereby providing a secure and durable installation of screen material 26.

### Sliding Screen Frame:

In the arrangement shown, as one example, sliding screen door system 10 includes a sliding screen frame 28. Sliding screen frame 28 may be formed of any suitable size, shape, and design and is configured to be attached to vehicle 12, or more specifically, to fixed screen frame 14 in a manner that allows for sliding motion of sliding screen frame 28 such that sliding screen frame 28 may overlap fixed screen frame 14 in an open position and cover the remaining portion of opening 60 not covered by fixed screen frame 14.

In the arrangement shown, as one example, sliding screen frame 28 includes a front member 30, a rear member 32, a top member 34, a bottom member 36, at least one cross member 38, screen material 26 and at least one corner section 40, among other components and features as is described herein.

In one arrangement, sliding screen frame 28 is largely formed of a light but strong metallic material such as an extruded aluminum or aluminum alloy material that is painted, anodized, powder coated or otherwise provided with a surface treatment or covering that provides an aesthetically pleasing appearance that is pleasant to the touch. Sliding screen frame 28 may be formed of any other material such as any other metallic material, such as steel, iron, or any other metal or alloy, alternatively a plastic, composite or any other non-metallic material may be used, or alternatively any combination of these materials may be used such as a combination of non-metallic material with metallic material.

Front Member: Front member 30 is formed of any suitable size, shape, and design and is configured to form the rigid support structure of the front edge of sliding screen frame 28. In the arrangement shown, as one example, front member 30 is formed of an elongated generally rectangular shaped member that has a width (when viewed from the exterior side or interior side) that is wider than its thickness (when viewed from the front side or rear side). In the arrangement shown, as one example, front member 30, when viewed from an interior side or an exterior side, is a generally straight elongated frame member. In the arrangement shown, as one example, front member 30, when viewed from a forward side or a rearward side, is a generally curved elongated frame member that curves in a concave manner toward the interior of vehicle 12.

In the arrangement shown, as one example, the upper end of front member 30 connects to the forward end of top member 34, and similarly, the lower end of front member 30 connects to the forward end of bottom member 36. In the arrangement shown, as one example, the top end of front member 30 connects to the forward end of top member 34 in a 45-degree intersection. Similarly, in the arrangement shown, as one example, the bottom end of front member 30 connects to the forward end of bottom member 36 in a 45-degree intersection. Using a 45-degree intersection, also known as a picture frame joint, provides a clean corner and a strong joint with an increased surface area of contact between joined components. However, any other form of a joint is hereby contemplated for use such as a butt joint, a square joint or any other joint. In one arrangement, front member 30 is connected to top member 34 and bottom member 36 by welding. However, any other manner, method or means of connecting two components together is hereby contemplated for use such as screwing, bolting, gluing, adhering, friction fitting, using interlocking members, using fasteners, riveting, or the like or any combination thereof. Alternatively, sliding screen frame 28 is formed of a single solid and unitary component that is formed by molding, casting, machining or otherwise.

In the arrangement shown, as one example, front member 30 extends in a generally parallel spaced manner to rear member 32. In the arrangement shown, as one example, front member 30 extends in a generally perpendicular manner to top member 34 and bottom member 36. However, any other arrangement is hereby contemplated for use.

Rear Member: Rear member 32 is formed of any suitable size, shape, and design and is configured to form the rigid support structure of the rear edge of sliding screen frame 28. In the arrangement shown, as one example, rear member 32 is formed of an elongated generally rectangular shaped member that has a width (when viewed from the exterior side or interior side) that is wider than its thickness (when viewed from the front side or rear side). In the arrangement shown, as one example, rear member 32, when viewed from an interior side or an exterior side, is a generally straight elongated frame member. In the arrangement shown, as one example, rear member 32, when viewed from a forward side or a rearward side, is a generally curved elongated frame member that curves in a concave manner toward the interior of vehicle 12.

In the arrangement shown, as one example, the upper end of rear member 32 connects to the rearward end of top member 34, and similarly, the lower end of rear member 32 connects to the rearward end of bottom member 36. In the arrangement shown, as one example, the top end of rear member 32 connects to the rearward end of top member 34 in a 45-degree intersection. Similarly, in the arrangement shown, as one example, the bottom end of rear member 32 connects to the rearward end of bottom member 36 in a 45-degree intersection. Using a 45-degree intersection, also known as a picture frame joint, provides a clean corner and a strong joint with an increased surface area of contact between joined components. However, any other form of a joint is hereby contemplated for use such as a butt joint, a square joint or any other joint. In one arrangement, rear member 32 is connected to top member 34 and bottom member 36 by welding. However, any other manner, method or means of connecting two components together is hereby contemplated for use such as screwing, bolting, gluing, adhering, friction fitting, using interlocking members, using fasteners, riveting, or the like or any combination thereof.

In the arrangement shown, as one example, rear member 32 extends in a generally parallel spaced manner to front member 30. In the arrangement shown, as one example, rear member 32 extends in a generally perpendicular manner to top member 34 and bottom member 36. However, any other arrangement is hereby contemplated for use.

Top Member: Top member 34 is formed of any suitable size, shape, and design and is configured to form the rigid support structure of the top edge of sliding screen frame 28. In the arrangement shown, as one example, top member 20 is formed of an elongated generally rectangular shaped member that has a width (when viewed from the exterior side or interior side) that is wider than its thickness (when viewed from the front side or rear side). In the arrangement shown, as one example, top member 34, when viewed from an interior side or an exterior side, is a generally straight elongated frame member. In the arrangement shown, as one example, top member 34, when viewed from a forward side or a rearward side, is a generally straight elongated frame member.

In one arrangement, as one example, the forward end of top member 34 connects to the top end of front member 30, and similarly, the rearward end of top member 34 connects to the top end of rear member 32. In one arrangement, as one example, the forward end of top member 34 connects to the top end of front member 30 in a 45-degree intersection. Similarly, in the arrangement shown, as one example, the rearward end of top member 34 connects to the top end of rear member 32 in a 45-degree intersection. Using a 45-degree intersection, also known as a picture frame joint, provides a clean corner and a strong joint with an increased surface area of contact between joined components. However, any other form of a joint is hereby contemplated for use such as a butt joint, a square joint or any other joint. In one arrangement, top member 34 is connected to front member 30 and rear member 32 by welding. However, any other manner, method or means of connecting two components together is hereby contemplated for use such as screwing, bolting, gluing, adhering, friction fitting, using interlocking members, using fasteners, riveting, or the like or any combination thereof.

In the arrangement shown, as one example, top member 34 extends in a generally parallel spaced manner to bottom member 36. In the arrangement shown, as one example, top member 34 extends in a generally perpendicular manner to front member 30 and rear member 32. However, any other arrangement is hereby contemplated for use.

Bottom Member: Bottom member 36 is formed of any suitable size, shape, and design and is configured to form the rigid support structure of the bottom edge of sliding screen frame 28. In the arrangement shown, as one example, bottom member 36 is formed of an elongated generally rectangular shaped member that has a width (when viewed from the exterior side or interior side) that is wider than its thickness (when viewed from the front side or rear side). In the arrangement shown, as one example, bottom member 36, when viewed from an interior side or an exterior side, is a generally straight elongated frame member. In the arrangement shown, as one example, bottom member 36, when viewed from a forward side or a rearward side, is a generally straight elongated frame member.

In the arrangement shown, as one example, the forward end of bottom member 36 connects to the bottom end of front member 30, and similarly, the rearward end of bottom member 36 connects to the bottom end of rear member 32. In the arrangement shown, as one example, the forward end of bottom member 36 connects to the bottom end of front member 30 in a 45-degree intersection. Similarly, in the arrangement shown, as one example, the rearward end of bottom member 36 connects to the bottom end of rear member 32 in a 45-degree intersection. Using a 45-degree intersection, also known as a picture frame joint, provides a clean corner and a strong joint with an increased surface area of contact between joined components. However, any other form of a joint is hereby contemplated for use such as a butt joint, a square joint or any other joint. In one arrangement, bottom member 36 is connected to front member 30 and rear member 32 by welding. However, any other manner, method or means of connecting two components together is hereby contemplated for use such as screwing, bolting, gluing, adhering, friction fitting, using interlocking members, using fasteners, riveting, or the like, or any combination thereof.

In the arrangement shown, as one example, bottom member 36 extends in a generally parallel spaced manner to top member 34. In the arrangement shown, as one example, bottom member 36 extends in a generally perpendicular manner to front member 30 and rear member 32. However, any other arrangement is hereby contemplated for use.

Cross Members: Cross member 38 are formed of any suitable size, shape, and design and is configured to form the rigid support structure of sliding screen frame 28 that extends across the hollow interior of sliding screen frame 28 and connects front member 30 and rear member 32. In the arrangement shown, as one example, a pair of cross members 38 are shown connecting opposing front member 30 and rear member 32. However, any number of cross members 38 are hereby contemplated for use such as none, one, two, three, four, five, six, seven, eight, nine, ten, or more. In the arrangement shown, as one example, the upper cross member 38 is positioned approximately one third of the way down from top member 34 and the lower cross member 38 is positioned at approximately two thirds of the way down from top member 34. However, any other placement and arrangement is hereby contemplated for use.

In the arrangement shown, as one example, cross members 38 are formed of an elongated generally rectangular shaped member that has a width (when viewed from the exterior side or interior side) that is wider than its thickness (when viewed from the front side or rear side). In the arrangement shown, as one example, cross members 38, when viewed from an interior side or an exterior side, are generally straight elongated frame members. In the arrangement shown, as one example, cross members 38, when viewed from a forward side or a rearward side, are a generally straight elongated frame member.

In the arrangement shown, as one example, the forward end of cross members 38 connect to the rearward side of front member 30, and similarly, the rearward end of cross members 38 connect to the forward side of rear member 32. In the arrangement shown, as one example, the forward end of cross members 38 connect to the rearward side end of front member 30 in a 90-degree intersection. Similarly, in the arrangement shown, as one example, the rearward end of cross members 38 connect to the forward end of rear member 32 in a 90-degree intersection. However, any other form of a joint is hereby contemplated for use such as a butt joint, a square joint or any other joint. In one arrangement, cross members 38 are connected to front member 30 and rear member 32 by welding. However, any other manner, method or means of connecting two components together is hereby contemplated for use such as screwing, bolting, gluing, adhering, friction fitting, using interlocking members, using fasteners, riveting, or the like, or any combination thereof.

In the arrangement shown, as one example, cross members 38 extend in a generally parallel spaced manner to top member 34 and bottom member 36. In the arrangement shown, as one example, cross members 38 extend in a generally perpendicular manner to front member 30 and rear member 32. However, any other arrangement is hereby contemplated for use.

Corner Section: In the arrangement shown, as one example, sliding screen frame 28 includes at least one corner section 40. Corner section 40 is formed of any suitable size, shape, and design and is configured to conform one or both of the forward corners of sliding screen frame 28 to fit the contour and shape of the opening 60 of vehicle 12 with close and tight tolerances so as to seal the forward edge of sliding frame member 28 with the forward-upper corner and/or forward-lower corner of opening 60 in vehicle 12.

In the arrangement shown, as one example, a corner section 40 is placed at the intersection of the upper end of front member 30 and the forward end of top member 34. However, it is also contemplated that a corner section 40 may be placed at the intersection of the lower end of front member 30 and the forward end of bottom member 34.

In the arrangement shown, as one example, corner section 40 is a smooth and rounded 90-degree corner that is formed of approximately the same shaped member as that which forms front member 30 and/or top member 34. However, any other arrangement is hereby contemplated for use. In the arrangement shown, as one example, the forward end of top member 34 engages the rearward end of corner section 40 and the upper end of front member 30 engages the lower end of corner section 40 in a flat and flush butt joint. In one arrangement, the upper end of front member 30 as well as the forward end of top member 34 are connected to corner section 40 by welding. However, any other manner, method or means of connecting two components together is hereby contemplated for use such as screwing, bolting, gluing, adhering, friction fitting, using interlocking members, using fasteners, riveting, or the like, or any combination thereof.

Like the other components of sliding screen frame 28, the interior facing edge of corner section 40 includes a channel 82 therein that receives the outer edge of screen material 26 therein.

Screen Material: In the arrangement shown, as one example, where two cross members 38 are used, sliding screen frame 28 is divided into three sections 80 or openings that are covered by screen material 26.

In the arrangement shown, as one example, the upper section 80 is defined between the rear surface of front member 30, the forward surface of rear member 32, the bottom surface of top member 34, the top surface of the upper cross member 38 and the interior surface of corner section 40. In the arrangement shown, as one example, the lower section 80 is defined between the rear surface of front member 30, the forward surface of rear member 32, the bottom surface of the lower cross member 38 and the top surface of the bottom cross member 38. In the arrangement shown, as one example, the middle section 80 is defined between the rear surface of front member 30, the forward surface of rear member 32, the bottom surface of the upper cross member 38 and the upper surface of the lower cross member 38.

Screen material 26 is formed of any suitable size, shape, and design and is configured to cover and close each section 80 in sliding screen frame 28 while allowing air to freely pass through these openings while simultaneously preventing bugs from entering vehicle 12. In the arrangement shown, as one example, screen material 26 is formed of a mesh material. However, any other form of material is hereby contemplated for use.

In the arrangement shown, as one example, screen material 26 is stretched across sections 80 and is secured to sliding screen frame 28 in a channel 82 in sliding screen frame 28 adjacent the opening of each section 80. In the arrangement shown, as one example, channel 82 extends in a continuous manner around the entire periphery of each section 80. In this way, screen material 26 may be secured to sliding screen frame 28 around the entire peripheral edge of each section 80 thereby providing a secure and durable installation of screen material 26.

### Top Rail:

In the arrangement shown, as one example, sliding screen door system 10 includes a top rail 42. Top rail 42 may be formed of any suitable size, shape, and design and is configured to connect to fixed screen frame 14 as well as connect to the vehicle 12 adjacent the top edge 64 of opening 60. Top rail 42 is also configured to provide a channel that provides alignment and guidance to sliding screen frame 28 while facilitating sealing the interface between fixed screen frame 14 and sliding screen frame 28.

In the arrangement shown, as one example, top rail 42 includes a forward wall 84, a center wall 86 and a rear wall 88 that form a channel 90 positioned between the rearward facing surface of forward wall 84, the bottom surface of center wall 86 and the forward facing surface of rear wall 88. The upper end of sliding screen frame 28 is configured to be received within this channel 90. In the arrangement shown, as one example, top rail 42 extends in a generally straight and continuous manner between opposing ends 92. In the arrangement shown, as one example, forward wall 84 and rear wall 88 extend in approximate parallel spaced relation to one another. In the arrangement shown, as one example, forward wall 84 and rear wall 88 extend in approximate perpendicular alignment to center wall 86. In this way, channel 90 is generally U-shaped or, said another way, a squared channel. However, any other configuration is hereby contemplated for use.

In the arrangement shown, as one example, slots 94 are placed in center wall 86 that are configured to facilitate affixing top rail 42 to vehicle 12 adjacent the top edge 64 of opening 60. In the arrangement shown, as one example, slots 94 extend a length that is aligned in a parallel manner with the end 92 to end 92 length of top rail 42. Aligning the length of slots 94 in this manner allows for lateral adjustment of top rail 42 relative to vehicle 12. In the arrangement shown, a plurality of slots 94 are positioned along the length of top rail 42 between opposing ends 92.

In the arrangement shown, as one example, slots 94 are placed in center wall 86 that are configured to facilitate affixing top rail 42 to vehicle 12 adjacent the top edge 64 of opening 60. In the arrangement shown, as one example, slots 94 extend a length that is aligned with the end 92 to end 92 length of top rail 42. Said another way, slots 94 are laterally aligned. Aligning the length of slots 94 in this manner allows for lateral adjustment of top rail 42 relative to vehicle 12. Conventional fasteners, such as screws, bolts or the like are passed through slots 94 and into vehicle 12, or a component attached to vehicle 12, thereby affixing top rail 42 to vehicle 12.

In the arrangement shown, as one example, slots 96 are placed in rear wall 88 that are configured to facilitate affixing top rail 42 to fixed screen frame 14, or more specifically, to the top member 20 of fixed screen frame 14. In the arrangement shown, as one example, slots 96 extend a length that is aligned in a perpendicular manner with the end 92 to end 92 length of top rail 42. Said another way, slots 96 are vertically aligned. Aligning the length of slots 96 in this manner allows for vertical adjustment of top rail 42 relative to fixed screen frame 14. In the arrangement shown, a plurality of slots 96 are positioned along the length of top rail 42 between opposing ends 92.

In the arrangement shown, as one example, slots 96 are placed in rear wall 88 that are configured to facilitate affixing top rail 42 to fixed screen frame 14 adjacent the top member 20. In the arrangement shown, as one example, slots 96 extend a length that is aligned in a perpendicular manner with the end 92 to end 92 length of top rail 42. Aligning the length of slots 96 in this manner allows for vertical adjustment of top rail 42 relative to fixed screen frame 14. Conventional fasteners, such as screws, bolts or the like are passed through slots 96 and into fixed screen frame 14 and/or top member 24, thereby affixing top rail 42 to fixed screen frame 14.

### Bottom Rail:

In the arrangement shown, as one example, sliding screen door system 10 includes a bottom rail 44. Bottom rail 44 may be formed of any suitable size, shape, and design and is configured to connect to fixed screen frame 14 as well as connect to the vehicle 12 adjacent the bottom edge or door sill 62 of opening 60. In this way, bottom rail 44 connects the bottom end of fixed screen frame 14 to vehicle 12

In the arrangement shown, as one example, bottom rail 44 includes a rear wall 98 and a bottom wall 100 that together form an L-shaped member. In the arrangement shown, as one example, bottom rail 44 extends in a generally straight and continuous manner between opposing ends 102. In the arrangement shown, as one example, rear wall 98 and bottom wall 100 extend in approximate perpendicular relation to one another. In this way, bottom rail 44 forms a square L-shaped member. However, any other configuration is hereby contemplated for use.

In the arrangement shown, as one example, slots 104 are placed in rear wall 98 that are configured to facilitate affixing bottom rail 44 to bottom member 22 of fixed screen frame 14. In the arrangement shown, as one example, slots 104 extend a length that is aligned in a perpendicular manner with the end 102 to end 102 length of bottom rail 44. Aligning the length of slots 104 in this manner allows for vertical adjustment of bottom rail 44 relative to fixed screen frame 14. In the arrangement shown, a plurality of slots 104 are positioned along the length of bottom rail 44 between opposing ends 102.

In the arrangement shown, as one example, slots 104 are placed in rear wall 98. The slots 104 are configured to facilitate affixing bottom rail 44 to bottom member 22 of fixed screen frame 14. In the arrangement shown, as one example, slots 104 extend a length that is aligned perpendicular with the end 102 to end 102 length of bottom rail 44. Said another way, slots 104 are vertically aligned. Aligning the length of slots 104 in this manner allows for vertical adjustment of bottom rail 44 relative to bottom member 22 of fixed screen frame 14. Conventional fasteners, such as screws, bolts or the like are passed through slots 104 and into bottom member 22 of fixed screen frame 14, thereby affixing bottom rail 44 to fixed screen frame 14.

In the arrangement shown, as one example, slots 106 are placed in bottom wall 100 that are configured to facilitate affixing bottom rail 44 to vehicle 12, or more specifically, to the area of vehicle 12 adjacent the lower side of opening 60 at or near door sill 62. In the arrangement shown, as one example, slots 106 extend a length that is aligned in a parallel manner with the end 102 to end 102 length of top rail 42. Said another way, slots 106 are horizontally aligned. Aligning the length of slots 106 in this manner allows for lateral adjustment of bottom rail 44 relative to opening 60 of vehicle 12. In the arrangement shown, a plurality of slots 106 are positioned along the length of bottom rail 44 between opposing ends 102.

In the arrangement shown, as one example, slots 106 are placed in bottom wall 100 that are configured to facilitate affixing bottom rail 44 to vehicle 12 adjacent the lower end of opening 60 adjacent door sill 62. In the arrangement shown, as one example, slots 106 extend a length that is aligned in a parallel manner with the end 102 to end 102 length of bottom rail 44. Aligning the length of slots 106 in this manner allows for lateral adjustment of bottom rail 44 relative to vehicle 12. Conventional fasteners, such as screws, bolts or the like are passed through slots 106 and into vehicle 12, or a component attached to vehicle 12, thereby affixing top rail 42 to vehicle 12.

### Kick Plate:

In the arrangement shown, as one example, sliding screen door system 10 includes a kick plate 46. Kick plate 46 may be formed of any suitable size, shape, and design and is configured to connect to the bottom end of sliding screen frame 28 and cover a portion of the area between the bottom of bottom member 36 of sliding screen frame 28 and the door sill 62 or another component of opening 60 of vehicle 12. In this way, kick plate 46 seals the opening of vehicle 12 when sliding screen frame 28 is in a closed position.

In the arrangement shown, as one example, kick plate 46 includes a rear wall 108, a bottom wall 110 and a forward wall 112 that extend in a generally continuous and straight manner between opposing ends 114. However, any other size, shape, design or configuration is hereby contemplated for use.

In the arrangement shown, as one example, rear wall 108 is a generally flat and planar member that connects at its upper end to bottom member 36 of sliding screen member 28 and connects at its lower end to the rearward end of bottom wall 110. In the arrangement shown, as one example, the upper end of rear wall 108 overlaps with and is positioned behind the bottom member 36 of sliding screen frame 28 and is affixed thereto. In the arrangement shown, as one example, rear wall 108 connects to bottom member 36 through a plurality of slots 116 that receive fasteners therein. In the arrangement shown, as one example, these slots 116 are vertically aligned so as to facilitate vertical adjustment of kick plate 46 relative to sliding screen frame 28.

In the arrangement shown, as one example, bottom wall 110 is a generally flat and planar member that connects at its rearward end to the lower end of rear wall 108 and connects at its forward end to the upper end of forward wall 112. In the arrangement shown, as one example, bottom wall 110 extends in an approximate perpendicular manner to rear wall 108. In the arrangement shown, as one example, bottom wall 110 extends in an approximate perpendicular manner to forward wall 112.

In the arrangement shown, as one example, forward wall 112 is a generally flat and planar member that connects at its upper end to the forward end of bottom wall 110 and terminates in a free end a distance below bottom wall 110. In the arrangement shown, as one example, forward wall 112 extends in an approximate parallel manner to rear wall 108. In the arrangement shown, as one example, forward wall 112 extends in an approximate perpendicular manner to bottom wall 110.

When kick plate 46 is assembled and installed on sliding screen frame 28, the rearward surface of rear wall 108 is positioned a small distance in front of the exterior surface of the bottom end of fixed screen frame 14. More specifically, the rearward surface of rear wall 108 is positioned a small distance in front of the lower end of front member 16, the lower end of rear member 18 and the bottom member 22. The rearward surface of rear wall 108 is also positioned a small distance in front of the exterior surface of rear wall 98 of bottom rail 44. Similarly, the lower surface of bottom wall 110 of kick plate 46 is positioned a small distance above the upper surface of bottom wall 100 of bottom rail 44. Similarly, the interior surface of forward wall 112 is positioned a small distance in front of the forward end of bottom wall 110 of bottom rail 44 and extends downward therefrom. In this way, kick plate 46 overlaps with and covers the lower end of fixed screen frame 14 thereby preventing bugs from penetrating the interior of vehicle 12 when sliding screen frame 28 is in a closed position while also facilitating free sliding of sliding screen frame 28 between an open position and a closed position without interference. Also, the interior facing surface of forward wall 112 overlaps with and/or is positioned just exterior of, a portion of vehicle 12 adjacent the lower end of opening 60 such as door sill 62 or another portion or component of vehicle 12 adjacent the lower end of opening 60.

In the arrangement shown, as one example, the vertical height of sliding screen frame 28 is shorter than the vertical height of fixed screen frame 14. This variation of height is to accommodate the vertical height of step 70 and the distance between door sill 62 and floor 72. This variation in height is also to accommodate and provide clearance for closing mechanism 78 of rear door 58. Clearance for closing mechanism 78 of rear door 58 is provided by movable member 48 which is positioned adjacent the forward end 114 of kick plate 46.

### Movable Member:

In the arrangement shown, as one example, sliding screen door system 10 includes a movable member 48. Movable member 48 may be formed of any suitable size, shape, and design and is configured to connect to the bottom end of sliding screen frame 28 adjacent the forward end 114 of kick plate 46 and cover a portion of the area between the bottom of bottom member 36 of sliding screen frame 28 and the door sill 62 or another component of opening 60 of vehicle 12 while also providing clearance for closing mechanism 78 of rear door 58 when rear door 58 is moved to a closed position.

More specifically, one problem with providing a screen door for vehicle 12 is that the forward side of opening 60 in vehicle 12 is particularly difficult to cover because rear door 58 includes a closing mechanism 78 that protrudes inward into opening 60 when rear door 58 is closed. That is, in the arrangement shown, closing mechanism 78 consists of an arm that extends inward from rear door 58 at the upper end and lower forward end of forward end of rear door 58.

These arms of closing mechanism 78 connect at their inward end to a rail that extends across the upper and lower ends of opening 60. To facilitate the inward motion of rear door 58 at the fully closed position, these rails extend inward and into the interior of vehicle 12 such that when rear door 58 is in an open position, rear door 58 is positioned exterior to the body of vehicle 12 whereas when rear door 58 is in a closed positon the exterior surface of rear door 58 is flush with the exterior surface of the body of vehicle 12.

This inward protrusion of closing mechanism 78 makes it difficult to provide a screen door that covers opening 60. In fact, some existing attempts to provide a screen door that covers opening 60 only work when the rear door 58 is opened. And, if these existing prior art screen doors are in a closed position when the rear door 58 of vehicle 12 is closed, the closing mechanism 78 hits and destroys the screen door, which is obviously extremely undesirable as it is highly likely that the rear door 58 will be closed when the screen door is closed.

The sliding screen door system 10 solves this problem with the addition of movable member 48. In the arrangement shown, as one example, movable member 48 is a generally flat and planar shaped member that extends a length between opposing ends 118 and extends a vertical height between upper end 120 and lower end 122. In the arrangement shown, as one example, the rearward end 118 of movable member 48 is positioned just forward of the forward end of rear wall 108 of kick plate 46 and extends in approximate parallel spaced relation thereto with only a small gap there between. In the arrangement shown, as one example, the forward end 118 of movable member 48 is positioned in approximate alignment with the forward end of front member 30 and extends in approximate parallel spaced relation thereto before terminating in the lower end 122 of movable member 48. In the arrangement shown, as one example, the lower end 122 of movable member 48 is positioned in approximate alignment with the lower end rear wall 108 of kick plate 46 and extends in approximate parallel spaced relation thereto. In the arrangement shown, as one example, the upper end 120 of movable member 48 is positioned in approximate alignment with the lower end bottom member 36 and extends in approximate parallel spaced relation thereto.

In the arrangement shown, as one example, the upper end 120 of movable member 48 is connected to the lower end bottom member 36 by a hinge member 124. Hinge member 124 is any form of a component that connects movable member 48 to bottom member 36 while also allowing for movement of movable member 48 inward when rear door 58 is closed and closing mechanism 78 engages movable member 48. In the arrangement shown, as one example, hinge member 124 is what is known as a barrel hinge that extends across a portion of, or all of, the upper end 120 of movable member 48 and connects to the lower end of bottom member 36. In the arrangement shown, as one example, when a barrel hinge is used, the barrel portion of hinge member 124 is positioned between bottom member 36 and movable member 48 and flanges connect to the rearward side of the upper end 120 of movable member 48 and the rearward side of the lower end of bottom member 36. In one arrangement, hinge member 124 includes a bias component, such as a spring member, that urges the movable member 48 to a closed position (or down position in the arrangement shown) while also allowing for inward movement of movable member 48. Alternatively, movable member 48 is maintained in a closed positon simply by gravity and in this arrangement there is no bias component, such as a spring member that urges movable member to a closed position. However, any other form of a hinge is hereby contemplated for use as well as any other arrangement.

In the arrangement shown, as one example, when sliding screen frame 28 is in a closed position when rear door 58 is closed, closing mechanism 78 moves inward at the end of the closing motion and engages the movable member 48. As the closing mechanism 78 engages movable member 48, the lower end 122 of movable member 48 moves rearward and upward as the upper end 120 of movable member 48 rotates upon hinge member 124. In this way, movable member 48 provides clearance for closing mechanism 78. Then, when rear door 58 is again opened, closing mechanism 78 moves outward. As the closing mechanism 78 disengages movable member 48, the lower end 122 of movable member 48 moves forward and downward as the upper end 120 of movable member 48 rotates upon hinge member 124. This continues until the closing mechanism 78 is completely disengaged from movable member 48 at which point movable member 48 again moves to a fully closed position.

In an alternative arrangement, movable member 48 connects to the forward end 114 of rear wall 108 of kick plate 46 by a hinge member 124.

### Flanges & Sealing Members:

In the arrangement shown, as one example, to facilitate sealing of seams or intersections of components of the sliding screen door system 10 and vehicle 12, flanges 126 may be used. In the arrangement shown, a flange 126 is positioned at the forward end 118 of movable member 48 that extends forward therefrom and is configured to engage the forward edge 68 of opening 60 when sliding screen frame 28 is in a closed position. Similarly, in the arrangement shown, a flange 126 is positioned at the lower end 122 of movable member 48 that extends downward therefrom and is configured to engage the door sill 62 or lower end of opening 60 when sliding screen frame 28 is in a closed position. Similarly, in the arrangement shown, a flange 126 is positioned at the forward end of front member 30 of sliding screen frame 28 that extends forward therefrom and is configured to engage the forward edge 68 of opening 60 when sliding screen frame 28 is in a closed position. It is hereby contemplated that a flange 126 may be placed at any other position of system 10 to seal system 10. Flange 126 may be formed of any component that helps to seal a space or gap between two components and may be formed of an overlapping member, a compressible member such as a rubber or foam or similar component, or any other component that facilitates sealing of two components.

In the arrangement shown, as one example, to facilitate sealing of seams or intersections of components of the sliding screen door system 10 and vehicle 12, sealing member 128 may be used. In the arrangement shown, a sealing member 128 is positioned at the upper end of sliding screen frame 28 that engages the top edge 64 of opening 60 thereby this intersection. Similarly, in the arrangement shown, a sealing member 128 is positioned at the lower end of sliding screen frame 28 that engages the top edge 64 of opening 60 thereby this intersection. In one arrangement, a sealing member 128 is connected to the exterior surface of front member 16 of fixed screen frame 14 that engages the interior surface of rear member 32 of sliding screen frame 28 when it is in a fully closed position. In one arrangement, a sealing member 128 is connected to the interior surface of rear member 32 of sliding screen frame 28 that engages the exterior surface of front member 16 of fixed screen frame 14 when it is in a fully closed position. In one arrangement, a sealing member 128 is connected to the exterior surface of front member 16 of fixed screen frame 14 that engages the interior surface of rear member 32 of sliding screen frame 28 when it is in a fully closed position. A sealing member 128 is also connected to the interior surface of rear member 32 of sliding screen frame 28 that engages the exterior surface of front member 16 of fixed screen frame 14 when it is in a fully closed position, thereby providing double layers of sealing and protection. It is hereby contemplated that a sealing member 128 may be placed at any other position of system 10 to seal system 10.

Sealing member 128 may be any form of a component that seals the intersection between two moving components while not inhibiting or preventing the movement of those two moving components. In the arrangement shown, as one example, sealing member 128 is formed of what is known as wool pile which has a rigid but flexible backing with fibers that extend outward therefrom that engage and thereby seal to adjacent components. In another arrangement, sealing member 128 is any other component that facilitates sealing of two components such as a compressible member such as a rubber or foam or similar component, or any other component that facilitates sealing of two components.

### Linear Slide:

In the arrangement shown, as one example, sliding screen door system 10 includes linear slides 50. Linear slides 50 may be formed of any suitable size, shape, and design and are configured to connect sliding screen frame 28 to fixed screen frame 14 while facilitating sliding movement of sliding screen frame 28 relative to fixed screen frame 14.

In the arrangement shown, as one example, two linear slides 50 are used in association with the system 10. However, any number of linear slides 50 are hereby contemplated for use such as one, two, three, four, five, six, or more.

In the arrangement shown, as one example, a linear slide 50 is connected to the upper cross member 24 of fixed screen frame 14 and the upper cross member 38 of the sliding screen frame 28. Similarly, in the arrangement shown, as one example, a linear slide 50 is connected to the lower cross member 24 of fixed screen frame 14 and the lower cross member 38 of the sliding screen frame 28. As the linear slides 50 connected to the upper cross members 24/38 and the lower cross members 24/38 are similar if not identical, for purposes of clarity and simplicity reference will be made generically to linear slides 50 and cross members 24/38 without reference separate reference to an upper cross member 24/38 or lower cross member 24/38 unless specifically stated herein.

In the arrangement shown, as one example, the use of two linear slides 50, one connected to the overlapping upper cross members 24/38 and one connected to the overlapping lower cross members 24/38 provides a strong, durable, rigid and long-lasting connection. The use of two linear slides 50 spaced a distance apart from one another, provides accurate alignment of sliding screen frame 28 as sliding screen frame 28 slides relative to fixed screen frame 14 between an open position and a closed position.

In addition, the use of two linear slides 50 to connect sliding screen frame 28 to fixed screen frame 14 has the effect of suspending sliding screen frame 28 or levitating sliding screen frame 28. This eliminates the need to have sliding screen frame 28 connect at its upper edge and lower edge to rails or grooves positioned at the area where the upper edge and lower edge of sliding screen frame 28 overlap with opening 60. Said another way, by suspending sliding screen frame 28 upon fixed screen frame 14 this eliminates the need for an upper rail or groove and lower rail or groove that sliding screen frame 28 slides in. This allows the portion of opening 60, which is covered by sliding screen frame 28 when sliding screen frame 28 is in a closed position, to be unencumbered by a rail or groove or other component. Instead, this portion of opening 60 (e.g., the upper surface of door sill 62 and/or the lower surface of top edge 64) has no components at all and is completely unaffected or unchanged by the presence of sliding screen door system 10. This provides an improved aesthetic appearance as well as providing improved safety as there is no rail or groove for a person to trip on and/or bump their head on. In addition, by not needing any rail or groove in opening 60 this maximizes the size of the opening 60.

Linear slides 50 may be formed of any component that facilitates sliding movement of sliding screen frame 28 relative to fixed screen frame 14. In the arrangement shown, linear slides 50 include an internal member 52, an external member 54 and a center member 56 that slide relative to one another and are engaged with one another in locking engagement with a plurality of bearings 130, which in the arrangement shown are ball bearings or roller bearings, positioned between internal member 52, external member 54 and center member 56. In the arrangement shown, as one example, linear slides 50 are connected to the exterior surface of cross member 24 of fixed screen frame 14 as well as to the interior surface of cross member 38 of sliding screen frame 28. However, the opposite arrangement is also hereby contemplated for use. In the arrangement shown, as one example, linear slides 50 extend most if not all of the length of cross members 24/38. The longer linear slides 50 are, the greater the surface area of connection and, therefore, the strength of the connection and accuracy of alignment is between fixed screen frame 14 and sliding screen frame 28.

Internal member 52 may be formed of any suitable size, shape, and design. In the arrangement shown, as one example, internal member 52 is connected to the exterior surface of cross frame member 24 of fixed screen frame 14. In the arrangement shown, as one example, internal member 52 includes a center wall 132, end walls 134 and flanges 136 among other components and features.

In the arrangement shown, as one example, center wall 132 is a generally flat and straight member that is connected to the exterior surface of cross member 24 of fixed screen frame 14 in a generally flat and flush alignment using one or more fasteners such as screws, bolts, fastening members or the like. However, any other manner, method or means of connecting center wall 132 to cross member 24 is hereby contemplated for use such as welding, gluing, and adhering or the like. Alternatively, it is hereby contemplated that the features of internal member 52 may be formed or machined into cross member 24. In the arrangement shown, as one example, end walls 134 connect to the upper and lower edges of center wall 132 and extend a distance outward therefrom away from fixed screen frame 14 and toward sliding screen frame 28. In the arrangement shown, as one example, end walls 134 are generally flat and straight members that extend in approximate perpendicular alignment to center wall 132. In the arrangement shown, as one example, flanges 136 connect to the forward edges of end walls 134 and extend a distance toward one another before terminating in a free end. In the arrangement shown, as one example, flanges 136 are generally flat and straight members that extend in approximate perpendicular alignment to end walls 134 and extend in approximate parallel spaced relation to center wall 132. In this way, the combination of center wall 132, end walls 134 and flanges 136 form a generally C-shaped or square shaped channel or hollow interior within internal member 52 that is configured to receive external member 54 and center member 56 therein. In the arrangement shown, as one example, the inward facing surfaces of end walls 134 include recesses therein that are sized and shaped to receive bearings 130 therein.

External member 54 may be formed of any suitable size, shape, and design. In the arrangement shown, as one example, external member 54 is connected to the interior surface of cross member 38 of sliding screen frame 28. In the arrangement shown, as one example, external member 54 includes a center wall 138 and end walls 140 among other components and features.

In the arrangement shown, as one example, center wall 138 is a generally flat and straight member that is connected to the interior surface of cross member 38 of sliding screen frame 28 in a generally flat and flush alignment using one or more fasteners such as screws, bolts, fastening members or the like. However, any other manner, method or means of connecting center wall 138 to cross member 38 is hereby contemplated for use such as welding, gluing, and adhering or the like. Alternatively, it is hereby contemplated that the features of external member 54 may be formed or machined into cross member 38. In the arrangement shown, as one example, end walls 140 connect to the upper and lower edges of center wall 138 and extend a distance outward therefrom away from sliding screen frame 28 and toward fixed screen frame 14. In the arrangement shown, as one example, end walls 140 are curved members, when viewed from the forward or rearward end, that include a concave surfaces that face away from one another that are configured to receive bearings 130 therein. That is, said another way, the upper and lower surfaces of end walls 140 have concave curved surfaces that receive bearings 130 therein. In the arrangement shown, as one example, center member 56 is positioned between internal member 52 and external member 54.

Center member 56 may be formed of any suitable size, shape, and design. In the arrangement shown, as one example, center member 56 connects at its inward facing surfaces to external member 54 and connects at its outward facing surfaces to internal member 52 by bearings 130 positioned between internal member 52 and center member 56 as well as between external member 54 and center member 56. In the arrangement shown, as one example, center member 56 includes a center wall 142 and end walls 144 having an interior section 146 and an exterior section 148 other components and features.

In the arrangement shown, as one example, center wall 142 includes a generally flat center section that connect at its upper and lower ends to angled sections that extend toward internal member 52 at an angle before connecting to generally flat exterior sections that extend in approximate parallel spaced relation to the center section. The upper and lower ends of exterior sections of center wall 142 connect to end walls 144. In the arrangement shown, as one example, end walls 144 connect to the upper and lower edges of center wall 142 and extend a distance outward therefrom away from fixed screen frame 14 and toward sliding screen frame 28. In the arrangement shown, as one example, end walls 144 are include two curved members, interior section 146 and exterior section 148, when viewed from the forward or rearward end, that include a concave surfaces that are configured to receive bearings 130 therein.

In the arrangement shown, as one example, the interior section 146, which is positioned adjacent the outward ends of center wall 142, have concave curved surfaces that face away from one another that receive bearings 130. These bearings connect on one side to interior section 146 of end walls 144 of center member 56 and connect on an opposite side to end walls 134 of internal member 52.

In the arrangement shown, as one example, the exterior section 148, which is positioned adjacent the outward ends of end walls 144, is separated from center wall 142 by interior sections 146, which have concave curved surfaces that face toward one another that receive bearings 130. These bearings 130 connect on one side to exterior section 148 of end walls 144 of center member 56 and connect on an opposite side to end walls 140 of external member 54.

The arrangement of internal member 52, external member 54 and center member 56 with bearings 130 positioned there between allows internal member 52 and external member 54 to slide relative to one another with movable center member 56 overlapping portions of internal member 52 and external member 54. This arrangement, and the overlapping length of center member 56, allows for accurate guidance and alignment of sliding screen frame 28 relative to fixed screen frame. In addition, this arrangement allows for only a small portion of sliding screen frame 28 to overlap fixed screen frame 14 when sliding screen frame 28 is fully closed. That is, in the arrangement shown, as one example, when sliding screen frame 28 is fully closed only the width of rear member 32 overlaps with fixed screen frame 14. Said another way, when sliding screen frame 28 is fully closed, only the front member 16 of fixed screen frame 14 is covered by the rear member 32 of sliding screen frame 28. In a fully closed position, approximately half of the center member 56 overlaps with approximately half of the internal member 52 connected to fixed screen frame 14, and approximately half of the center member 56 overlaps with approximately half of the external member 54 connected to sliding screen frame 28. This arrangement, and this substantial amount of overlap, provides a rigid and stable arrangement even when sliding screen frame 28 is fully extended upon linear slides 50 at a fully closed position.

### Handle & Latch/Lock:

In some embodiments, a handle 150 is connected to front member 30 of sliding screen frame 28. A latch 160 is positioned on rear member 32 and a detent 162 is positioned on front member 16. Handle 150, latch 160, and detent 162 are formed of any suitable size, shape, and design and are configured to facilitate opening and closing and latching of sliding screen frame 28. In the arrangement shown, as one example, latch 160 is configured to engage a detent 162 and hold sliding screen frame 28 in a closed position.

Additionally, or alternatively, in one or more embodiments, system 10 may include a lock 152 and receiver 154 closing and/or locking of sliding screen frame 28. Lock 152 and receiver 154 are formed of any suitable size, shape, and design and are configured to facilitate opening and closing and locking of sliding screen frame 28. In the arrangement shown, as one example, handle 150 and lock 152 engage a receiver 154 connected to forward edge 68 of opening 60 that facilitates locking of sliding screen frame 28 in a closed position.

### In Operation:

Sliding screen door system 10 is installed into vehicle 12 by aligning fixed screen frame 14 in the rearward side of opening 60. Once sliding screen door system 10 is properly aligned, the upper end of sliding screen door system 10 is fixed in place by screwing or bolting top rail 42 into vehicle 12 adjacent the top edge 64 of opening 60 by passing fasteners through slots 94 and into vehicle 12. Similarly, once sliding screen door system 10 is properly aligned, the lower end of sliding screen door system 10 is fixed in place by screwing or bolting bottom rail 44 into vehicle 12 adjacent the door sill 62 of opening 60 by passing fasteners through slots 106 and into vehicle 12. Any other component of fixed screen frame 14 may be attached to vehicle 12 by passing a fastener through fixed screen frame 14 and into vehicle 12

Once fixed screen frame 14 is fixed to vehicle 12, sliding screen frame 28 is suspended in place upon fixed screen frame 14 within opening 60 without any other attachments or components. Once fixed screen frame 14 is fixed to vehicle 12, sliding screen frame 28 is free to slide back and forth upon linear slides 50 between a fully open position and a fully closed position.

As sliding screen frame 28 slides from an open position to a closed position, the external member 54 of linear slide 50 slides relative internal member 52 with center member 56 there between. The structure and shape of linear slides 50 prevents substantial movement of sliding screen frame 28 other than lateral sliding movement between the open position and closed position.

When sliding screen frame 28 is in a fully open position, the front member 30, rear member 32, top member 34 and cross members 38 overlap the front member 16, rear member 18, top member 20 and cross members 24 of fixed screen frame 14 respectively. In a fully closed position, the rear member 32 of sliding screen frame 28 overlap with the front member 16 of fixed screen frame 14. Also, only a small portion of the forward end of internal member 52 of linear slide 50 overlaps with a small portion of the rearward end of external member 54 of linear slide 50 with about half of the center member 56 overlapping internal member 52 and about half of the center member 56 overlapping external member 54.

As sliding screen frame 28 slides from an open position to a closed position, the upper end of sliding screen frame 28 moves laterally within the channel 90 formed by top rail 42. As sliding screen frame 28 slides from an open position to a closed position, the lower end of sliding screen frame 28 laterally moves just in front of the lower end of fixed screen frame 14. As sliding screen frame 28 slides from an open position to a closed position, as the sliding screen frame 28 has approximately the same curvature as fixed screen frame 14, the entirety of sliding screen frame 28 moves in approximate parallel spaced relation across the exterior side of fixed screen frame 14.

In a fully closed position, the forward edge of sliding screen frame 28 engages and seals to the forward edge 68 of opening 60 thereby closing opening 60 and preventing bugs from penetrating the interior of vehicle 12. In a fully closed position, latch 160 engaged a detent 162 to hold sliding screen frame 28 in a closed position. Additionally or alternatively, in a fully closed position handle 150 and lock 152 may be locked to receiver 154 thereby locking sliding screen frame 28 in a closed position.

In a fully closed position, kick plate 46 encloses the distance between the lower end of bottom member 36 of sliding screen frame 28 and door sill 62 with the forward wall 112 of kick plate 46 positioned just in front of and covering a forward portion of door sill 62 thereby sealing this portion of opening. Forward of kick plate 46, moveable member 48 encloses the distance between the lower end of bottom member 36 of sliding screen frame 28 and door sill 62.

When sliding screen frame 28 is in a closed position when rear door 58 is closed, closing mechanism 78 moves inward at the end of the closing motion and engages the movable member 48. As the closing mechanism 78 engages movable member 48, the lower end 122 of movable member 48 moves rearward and upward as the upper end 120 of movable member 48 rotates upon hinge member 124. In this way, movable member 48 provides clearance for closing mechanism 78. When rear door 58 is opened again, closing mechanism 78 moves outward. As the closing mechanism 78 disengages movable member 48, the lower end 122 of movable member 48 moves forward and downward as the upper end 120 of movable member 48 rotates upon hinge member 124. This continues until the closing mechanism 78 is completely disengaged from movable member 48 at which point movable member 48 again moves to a fully closed position.

In a fully closed position, sealing members 128 and flanges 126 block spaces or openings positioned between portions of sliding screen frame 28 and fixed screen frame 14, and/or between sliding screen frame 28 and portions of vehicle 12, and/or between sliding screen frame and other components of system 10 thereby preventing bugs from penetrating the interior of vehicle 12.

In this way a strong and durable sliding screen door system 10 is presented for a vehicle 12 that is aesthetically pleasing, easy to use, does not require rails at the top or bottom of the opening 60 among countless other features and benefits.

From the above discussion it will be appreciated that the sliding screen door system 10 presented herein improves upon the state of the art. More specifically, and without limitation, it will be appreciated that, in one or more embodiments, the sliding screen door system 10 presented herein that: may be installed in complex openings; may be installed in vehicles; is easy to use; does not require a bottom rail at the opening and closing end; does not require a top rail at the opening and closing end; does not require both a bottom rail and a top rail at the opening and closing end; does not encumber the entryway of a vehicle; may be installed in a wide variety of vehicles; allows for the door of the vehicle to be closed while the sliding screen door is closed; allows the door of the vehicle to be closed while the sliding screen door is open; is not damaged or broken when the door of the vehicle is closed when the sliding screen door is closed; is robust; is durable; is easy to install; is easy to use; can be used with practically any vehicle that serves as a camper; provides a sliding screen frame that does not require connection to a rail at the upper or lower portion of the sliding screen frame; is relatively inexpensive; allows the sliding screen door to be curved; allows the sliding screen door to fit complex-shaped openings; is aesthetically pleasing; provides a lot of airflow through the opening; effectively prevents bugs from passing through the opening; effectively seals the opening; provides easy access into and out of the vehicle; is high quality; can be locked, among countless other advantages and improvements.

It will be appreciated by those skilled in the art that other various modifications could be made to the device without parting from the spirit and scope of this disclosure. All such modifications and changes fall within the scope of the claims and are intended to be covered thereby.

What is claimed:

1. A sliding screen door system for a vehicle, comprising:
a fixed screen frame;
the fixed screen frame having a front member a rear member, a top member and a bottom member, a first cross member, and a second cross member;
the fixed screen frame connected to an opening of the vehicle;
a first linear slide;
the first linear slide connected to the fixed screen frame;
a second linear slide;
the second linear slide connected to the fixed screen frame;
a sliding screen frame;
the sliding screen frame having a front member a rear member, a top member and a bottom member, a first cross member, and a second cross member;
the first linear slide connected to the sliding screen frame;
the second linear slide connected to the sliding screen frame;
wherein the sliding screen frame slides between an open position and a closed position;
wherein when in an open position access is provided into the vehicle through the opening;
wherein when in a closed position the opening in the vehicle is closed.

2. The system of claim 1, wherein:
the first linear slide is connected to the first cross member of the fixed screen frame; and
the second linear slide is connected to the second cross member of the fixed screen frame.

3. The system of claim 1, wherein the sliding screen frame is suspended relative to the fixed screen frame by connection of the sliding screen frame to the first linear slide and the second linear slide.

4. The system of claim 1, wherein the first linear slide and second linear slide facilitate sliding movement of the sliding screen frame relative to the fixed screen frame.

5. The system of claim 1, wherein when in an open position, the sliding screen frame overlaps the fixed screen frame.

6. The system of claim 1, wherein the sliding screen frame includes a top member that is not attached to the vehicle.

7. The system of claim 1, wherein the sliding screen frame includes a bottom member that is not attached to the vehicle.

8. The system of claim 1, wherein the sliding screen frame includes a top member and a bottom member that are not attached to the vehicle.

9. The system of claim 1, wherein the fixed screen frame and the sliding screen frame are curved when viewed from a front side or rear side.

10. The system of claim 1, further comprising a movable member connected to a bottom member of the sliding screen frame, wherein the movable member moves inward when a door of the vehicle is closed thereby preventing the sliding screen door system from being damaged when the door of the vehicle is closed.

11. The system of claim 1, further comprising a kick plate connected to a bottom member of the sliding screen frame; wherein the kick plate overlaps a portion of a door sill of the opening of the vehicle.

12. The system of claim 1, wherein the first linear slide includes an internal member, and external member and a center member, wherein in internal member, external member and center member slide with respect to one another.

13. A sliding screen door system, comprising:
a fixed screen frame;
the fixed screen frame configured and arranged for connecting to an opening of an enclosure;
a first linear slide;
the first linear slide connected to the fixed screen frame;
a sliding screen frame;
the sliding screen frame connected to the first linear slide;
wherein the sliding screen frame slides between an open position and a closed position;
wherein when the fixed screen frame is connected to the opening and the slicing screen frame is in the open position, access is provided into the enclosure through the opening;
wherein when the fixed screen frame is connected to the opening and the sliding screen frame is in the closed position, access into the enclosure thought the opening is prevented.

14. The system of claim 13, wherein the sliding screen frame is suspended relative to the fixed screen frame by connection of the sliding screen frame to the first linear slide.

15. The system of claim 13, wherein the first linear slide facilitates sliding movement of the sliding screen frame relative to the fixed screen frame.

16. The system of claim 13, wherein when in an open position, the sliding screen frame overlaps the fixed screen frame.

17. The system of claim 13, further comprising a second linear slide, the second linear slide connected to the fixed screen frame, the second linear slide connected to the sliding screen frame, wherein the first and second linear slides facilitate sliding movement of the sliding screen frame relative to the fixed screen frame.

18. The system of claim 13, wherein the sliding screen frame includes a top member that is not attached to the vehicle.

19. The system of claim 13, wherein the sliding screen frame includes a bottom member that is not attached to the vehicle.

20. The system of claim 13, wherein the sliding screen frame includes a top member and a bottom member that is not attached to the vehicle.

21. The system of claim 13, wherein the fixed screen frame and the sliding screen frame are curved when viewed from a front side or rear side.

22. The system of claim 13, further comprising a movable member connected to a bottom member of the sliding screen frame, wherein the movable member moves inward when a door of the vehicle is closed thereby preventing the sliding screen door system from being damaged when the door of the vehicle is closed.

23. The system of claim 13, wherein the first linear slide is connected to the fixed screen frame between a top member and a bottom member of the fixed screen frame.

24. The system of claim 13, wherein the first linear slide is connected to the sliding screen frame between a top member and a bottom member of the sliding screen frame.

25. A sliding screen door system, comprising:
a fixed screen frame;
the fixed screen frame configured and arranged for connecting to an opening of an enclosure;
a sliding screen frame;
wherein the sliding screen frame slides between an open position and a closed position;
wherein when the fixed screen frame is connected to the opening and the sliding screen frame is in the open position, access is provided into the enclosure through the opening;
wherein when the fixed screen frame is connected to the opening and the sliding screen frame is in the closed position access into the enclosure is prevented;
a movable member connected to a bottom member of the sliding screen frame, wherein the movable member is configured and arranged to move inward when a door of the enclosure is closed thereby preventing the sliding screen door system from being damaged when the door of the enclosure is closed.

26. The system of claim 25, wherein the sliding screen frame is suspended relative to the fixed screen frame by connection of the sliding screen frame to a first linear slide that is connected to the fixed screen frame.

27. The system of claim 25, further comprising a first linear slide and a second linear slide connected to the fixed screen frame and the sliding screen frame, wherein the first and second linear slides facilitate sliding movement of the sliding screen frame relative to the fixed screen frame.

28. The system of claim 25, wherein when in an open position, the sliding screen frame overlaps the fixed screen frame.

29. The system of claim 25, further comprising a latch connected to the sliding screen frame and a detent connected to the fixed screen frame, wherein the latch is configured and arranged to engage the detent when the sliding screen frame is in the closed position.
